(19) United States
(12) Patent Application Publication
(10) Pub. No.: US 2025/0286916 A1
(43) Pub. Date: Sep. 11, 2025

(54) MEC DUAL EDGE APP REGISTRATION ON BEHALF OF EDGE PLATFORM IN DUAL EDGE DEPLOYMENTS

(71) Applicant: Intel Corporation, Santa Clara, CA (US)

(72) Inventors: Miltiadis Filippou, München (DE); Dario Sabella, Gassino (IT); Samar Shailendra, Bangalore (IN)

(21) Appl. No.: 18/575,197

(22) PCT Filed: Nov. 2, 2022
(86) PCT No.: PCT/US2022/048693

§ 371 Date: Dec. 28, 2023

Related U.S. Application Data
(60) Provisional application No. 63/275,018, filed on Nov. 3, 2021.

(51) Int. Cl. H04L 65/1073; H04L 67/10; H04L 67/30; H04L 67/563

(52) U.S. Cl. CPC H04L 65/1073; H04L 67/10; H04L 67/30; H04L 67/563

(57) ABSTRACT

Various approaches for Multi-access Edge Computing (MEC) Dual Edge App Registration, including registration performed on behalf of edge computing platforms operating as dual deployments in a MEC and 3GPP infrastructure, are discussed. An example first computing platform may be communicatively coupled, via a network, to a second computing platform, and perform operations that: receive a dual application registration request from an application of the first computing platform; map a first application profile of the application at the first computing platform to a second application profile at the second computing platform; redirect the dual application registration request to the second computing platform; receive, in response to the redirect of the dual application registration request, an application registration acknowledgment; and provide, to the application, the application registration acknowledgment.

### PRIORITY CLAIM

This application claims the benefit of priority to U.S. Provisional Patent Application No. 63/275,018, filed Nov. 3, 2021, and titled “MEC DUAL EDGE APP REGISTRATION ON BEHALF OF EDGE PLATFORM IN DUAL EDGE DEPLOYMENTS”, which is incorporated herein by reference in its entirety.

### TECHNICAL FIELD

Embodiments described herein generally relate to data processing, network communication, and communication system implementations of multi-access edge computing (MEC) networks.

### BACKGROUND

Edge computing, at a general level, refers to the transition of compute and storage resources closer to endpoint devices (e.g., consumer computing devices, user equipment, etc.) to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

Edge computing use cases in mobile network settings have been developed for integration with MEC approaches, also known as “mobile edge computing.” MEC approaches are designed to allow application developers and content providers to access computing capabilities and an information technology (IT) service environment in dynamic mobile network settings at the edge of the network. Limited standards have been developed by the European Telecommunications Standards Institute (ETSI) industry specification group (ISG) in an attempt to define common interfaces for the operation of MEC systems, platforms, hosts, services, and applications.

Edge computing, MEC, and related technologies attempt to provide reduced latency, increased responsiveness, and more available computing power than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (devices, hosts, tenants, service providers, operators) are involved.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1A illustrates a MEC network architecture operable to implement app registration functions, according to an example embodiment;

FIG. 1B illustrates a MEC reference architecture in a Network Function Virtualization (NFV) environment, according to an example;

FIG. 1C illustrates an example MEC service operating in a MEC reference architecture, according to an example;

FIG. 2 illustrates dual registration in an ETSI MEC environment, according to an example;

FIG. 3 depicts a deployment instance following dual edge application registration, according to an example;

FIG. 4 depicts an Edge Application Server (EAS) registration procedure, according to an example;

FIG. 5 depicts a scenario where a MEC application instance sends an application registration request to the MEC platform, according to an example;

FIG. 6 depicts an additional detail of a dual application registration procedure, according to an example;

FIG. 7A depicts a single edge application registration to a 3GPP system, according to an example;

FIG. 7B depicts a single edge application registration to an ETSI MEC system, according to an example;

FIG. 8 depicts a dual edge application registration to 3GPP and ETSI MEC systems, according to an example;

FIG. 9 depicts a MEC App dual application registration sequence, according to an example;

FIG. 10 depicts an EAS dual application registration sequence, according to an example;

FIG. 11A depicts a deployment scenario with a co-located platform, according to an example;

FIG. 11B depicts a deployment scenario with a non-co-located platform, according to an example;

FIG. 12 illustrates a flowchart of a method for performing an application registration request with one or multiple platforms, according to an example;

FIG. 13 illustrates an overview of an edge cloud configuration for edge computing, according to an example;

FIG. 14 illustrates an overview of layers of distributed compute deployed among an edge computing system, according to an example;

FIG. 15 illustrates operational layers among endpoints, an edge cloud, and cloud computing environments, according to an example;

FIG. 16 illustrates an example approach for networking and services in an edge computing system, according to an example;

FIG. 17A illustrates an overview of example components deployed at a compute node system, according to an example;

FIG. 17B illustrates a further overview of example components within a computing device, according to an example; and

FIG. 18 illustrates a software distribution platform to distribute software instructions and derivatives, according to an example.

### DETAILED DESCRIPTION

The following focuses on the problem of registering an edge application (i.e., a MEC App, as defined by ETSI GS MEC 003 and an Edge Application Server (EAS), as defined by 3GPP SA6 EDGEAPP specification (3GPP TS 23.558)) to both an ETSI MEC Platform and a 3GPP EDGEAPP Edge Enabler Server (EES), without the need to establish separate edge application registrations. Thus, the following approaches enables improved development skills and extended application code to ensure that the edge application is discoverable by both systems (e.g., ETSI MEC and 3GPP EDGEAPP systems). Additional details are provided in the following sections, after an overview of MEC network architectures.

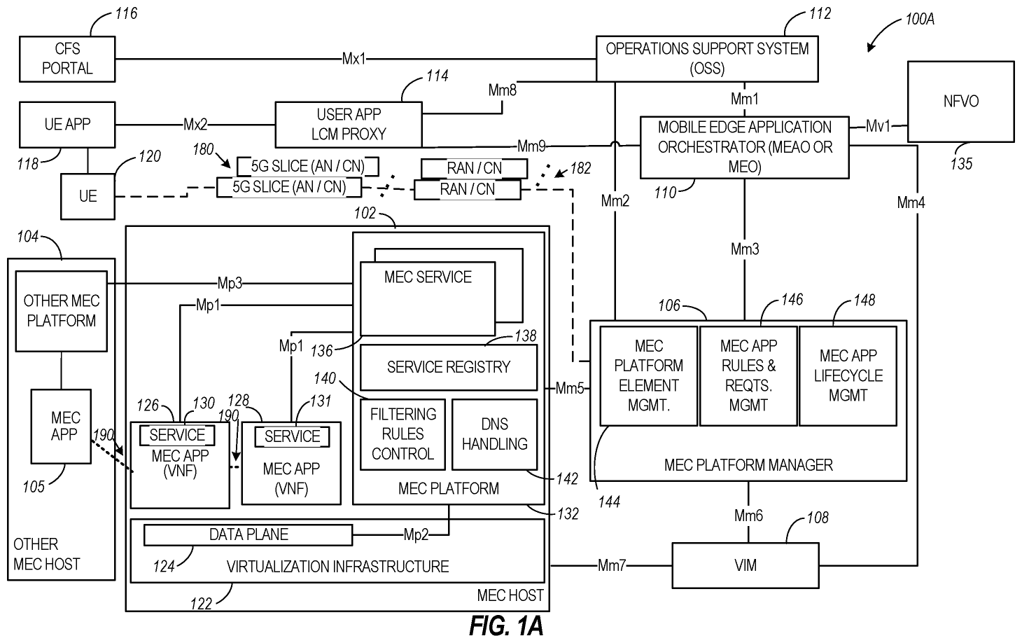

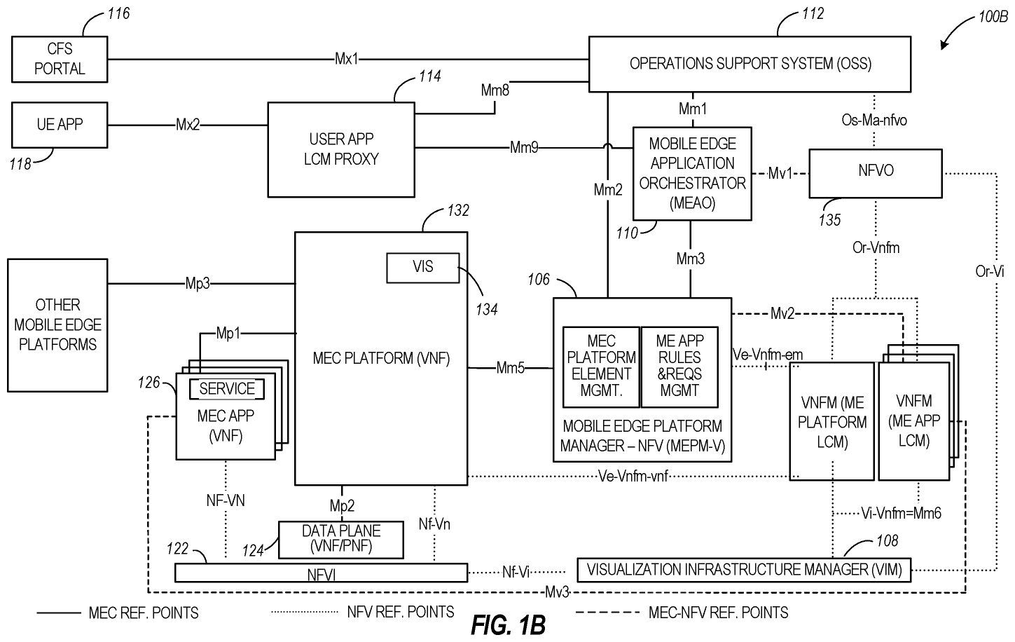

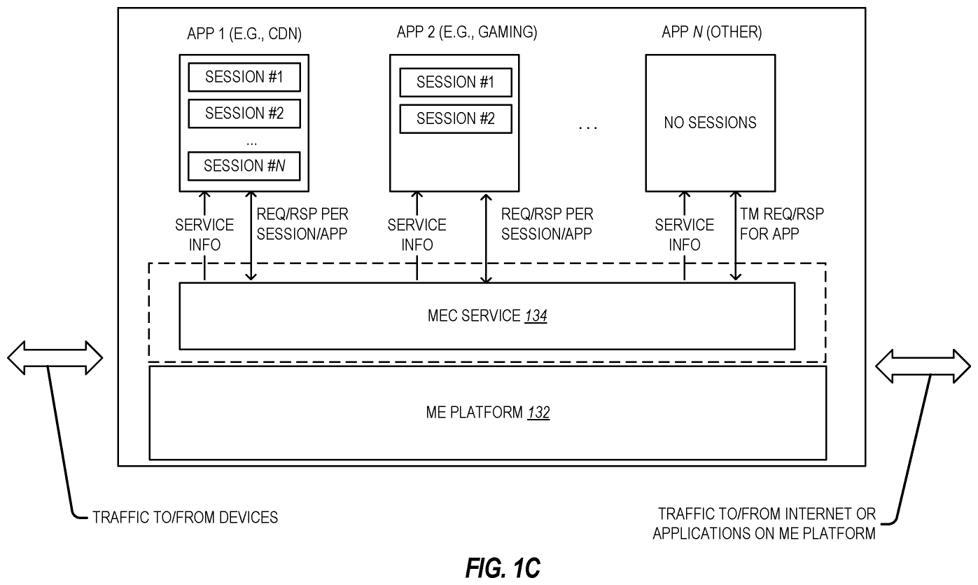

FIG. 1A illustrates a MEC network architecture used for implementing the present techniques. FIG. 1A specifically illustrates a MEC architecture 100A with MEC hosts 102 and 104 providing functionalities per one or more ETSI MEC specifications (e.g., ETSI GS MEC 003, ETSI GS MEC 011, and ETSI GS MEC 030 specifications). As one example, the MEC platform 132, APIs, and other aspects, can be used for implementing MEC services, applications, and functions within the MEC architecture 100A.

Referring to FIG. 1A, the MEC architecture 100A includes MEC hosts 102 and 104, a virtualization infrastructure manager (VIM) 108, a MEC platform manager 106 (also referred to as Mobile Edge Platform Manager or MEPM), a Mobile Edge Application Orchestrator (MEAO) (also referred to as a MEC orchestrator or MEO) 110, an operations support system (OSS) 112, a user app proxy 114, a UE app 118 running on UE 120, and CFS portal 116. The MEC host 102 can include a MEC platform 132 with filtering rules control module 140, a DNS handling module 142, service registry 138, and MEC services 136. The MEC host 104 can include resources used to instantiate MEC apps 105. The MEC services 136 can include at least one scheduler 137, which can be used to select resources for instantiating MEC apps (or VNFs) 126 and 128 upon virtualization infrastructure 122 that includes a data plane 124.

As one example, the MEC apps 126 and 128 can be configured to provide services 130/131, which can include processing network communications traffic of different types associated with one or more wireless connections. In some embodiments, the services 130/131 include message broker services configured to support multiple application layer protocols used in the collection/distribution of data from/to multiple data sources across different MNOs. For instance, services 130/131 provided by MEC apps may operate as V2X message brokers. In other embodiments, MEC apps 126 and 128 are used for V2X message subscription (e.g., to subscribe to V2X communications from V2X message brokers) and V2X message publication (e.g., to publish data to V2X message brokers which can be distributed to V2X message subscribers).

In some embodiments, a first MEC app (e.g., MEC app 105 in MEC host 104) can be configured as a V2X message broker, while a second MEC app (e.g., MEC app 126 in MEC host 102) can be configured as a MEC V2X message service subscriber/consumer. In this case, a communication link (e.g., a direct data connection) 190 may be established between two separate MEC apps (e.g., MEC apps in different MEC hosts or the same MEC host). In this regard, the V2X message broker is a service-producing MEC app. In other aspects, the V2X message broker may be configured as a registered service of the MEC platform 132, as a producer of data. In other words, the message broker is part of a MEC platform's service registry. In this case, communication with a MEC app requesting a subscription to a V2X messaging service is achieved, within the same MEC host, via the Mp1 interface and the connection to a common MEC platform. When the message broker service and the requestor MEC app are instantiated at different MEC hosts of the same MEC system, communication with a MEC app in another MEC host (in the same or different MNO) is achieved via the Mp3 interface (e.g., using a connection between MEC platforms in different MEC hosts). In case these different MEC hosts belong to different MEC systems of a MEC federation, then, instead of Mp3, MEC federation reference points are involved in this communication.

The MEC platform manager 106 can include MEC platform element management module 144, MEC app rules and requirements management module 146, and MEC app lifecycle management module 148.

In some aspects, UE 120 can be configured to communicate to one or more of the core networks 182 via one or more of the network slice instances (NSIs) 180 (e.g., implemented by an access network or core network). In some aspects, the core networks 182 can use slice management functions to dynamically configure NSIs 180, including dynamically assign a slice to a UE, configure network functions associated with the slice, configure a MEC app for communicating data using the slice, reassign a slice to a UE, dynamically allocate or reallocate resources used by one or more of the NSIs 180, or other slice related management functions. One or more of the functions performed in connection with slice management can be initiated based on user requests (e.g., via a UE), based on a request by a service provider, or maybe triggered automatically in connection with an existing Service Level Agreement (SLA) specifying slice-related performance objectives.

FIG. 1B illustrates a MEC reference architecture 100B in a Network Function Virtualization (NFV) environment, according to an example. The MEC architecture 100B can be configured to provide functionalities according to an ETSI MEC specification, such as the ETSI GR MEC 017 specification.

In some aspects, ETSI MEC can be deployed in an NFV environment as illustrated in FIG. 1B which can also implement application registration and usage functions in a MEC infrastructure. In some aspects, the MEC platform is deployed as a virtualized network function (VNF). The MEC applications can appear like VNFs towards the ETSI NFV Management and Orchestration (MANO) components (e.g., VIM 108, MEAO 110, and NFVO 135). This allows the re-use of ETSI NFV MANO functionality. In some aspects, the full set of MANO functionality may be unused and certain additional functionality may be needed. Such a specific MEC application is denoted by the name “MEC app VNF” (or ME app VNF) as discussed herein. In some aspects, the virtualization infrastructure is deployed as an NFVI and its virtualized resources are managed by the virtualized infrastructure manager (VIM). For that purpose, one or more of the procedures defined by ETSI NFV Infrastructure specifications (e.g., ETSI OS NFV-INF 003, ETSI GS NFV-INF 004, and ETSI GS NFV-INF 005) can be used.

In some aspects, the MEC app VNFs will be managed like individual VNFs, allowing that a MEC-in-NFV deployment can delegate certain orchestration and Life Cycle Management (LCM) tasks to the NFVO and VNFM functional blocks, as defined by ETSI NFV MANO. In some embodiments, the MEC app VNF can be configured as a V2X message broker or as a V2X app that consumes V2X services in a MEC architecture (e.g., V2X message subscription services provided by V2X message brokers from different MNOs).

In some aspects, the Mobile Edge Platform Manager (MEPM) 106 can be transformed into a “Mobile Edge Platform Manager—NFV” (MEPM-V) that delegates the LCM part to one or more virtual network function managers (VNFM(s)). The Mobile Edge Orchestrator (MEO), as defined in the MEC reference architecture ETSI GS MEC-003, can be transformed into a “Mobile Edge Application Orchestrator” (MEAO) 110 that uses the NFVO 135 for resource orchestration, and orchestration of the set of MEC app VNFs as one or more NFV Network Services (NSs). In some embodiments, the MEAO 110 and the MEPM 106 can be configured to perform federation management functions, including communication between MEC systems in a federated MEC network.

FIG. 1C illustrates an example MEC service operating in a MEC reference architecture (such as the architectures depicted in FIGS. 1A and 1B). Here, the MEC service architecture includes a MEC service 134, ME platform 132 (corresponding to the MEC platform 132 discussed in FIGS. 1A and 1B), and applications (Apps) 1 to N (where Nis a number). As an example, the App 1 may be a CDN app/service hosting 1 to n sessions (where n is a number that is the same or different than A), App 2 may be a gaming app/service which is shown as hosting two sessions, and App N may be some other app/service which is shown as a single instance (e.g., not hosting any sessions). Each App may be a distributed application that partitions tasks and/or workloads between resource providers (e.g., servers such as ME platform 132) and consumers (e.g., UEs, user apps instantiated by individual UEs, other servers/services, network functions, application functions, etc.). Each session represents an interactive information exchange between two or more elements, such as a client-side app and its corresponding server-side app, a user app instantiated by a UE and a MEC app instantiated by the ME platform 132, and/or the like. A session may begin when App execution is started or initiated and ends when the App exits or terminates execution. Additionally or alternatively, a session may begin when a connection is established and may end when the connection is terminated. Each App session may correspond to a currently running App instance. Additionally or alternatively, each session may correspond to a Protocol Data Unit (PDU) session or multi-access (MA) PDU session. A PDU session is an association between a UE and a DN that provides a PDU connectivity service, which is a service that provides for the exchange of PDUs between a UTE and a Data Network. An MA PDU session is a PDU Session that provides a PDU connectivity service, which can use one access network at a time, or simultaneously a 3GPP access network and a non-3GPP access network. Furthermore, each session may be associated with a session identifier (ID) which is data the uniquely identifies a session, and each App (or App instance) may be associated with an App ID (or App instance ID) which is data the uniquely identifies an App (or App instance).

The MEC service 134 provides one or more MEC services to MEC service consumers (e.g., Apps 1 to N). The MEC service 134 may optionally run as part of the platform (e.g., ME platform 132) or as an application (e.g., ME app). Different Apps 1 to N, whether managing a single instance or several sessions (e.g., CDN), may request specific service info per their requirements for the whole application instance or different requirements per session. The MEC service 134 may aggregate all the requests and act in a manner that will help optimize the BW usage and improve Quality of Experience (QoE) for applications.

The MEC service 134 provides a MEC service API that supports both queries and subscriptions (e.g., pub/sub mechanism) that are used over a Representational State Transfer (“REST” or “RESTful”) API or over alternative transports such as a message bus. For RESTful architectural style, the MEC APIs contain the HTTP protocol bindings for traffic management functionality. In an example, each Hypertext Transfer Protocol (HTTP) message is either a request or a response. A server listens on a connection for a request, parses each message received, interprets the message semantics in relation to the identified request target, and responds to that request with one or more response messages. A client constructs request messages to communicate specific intentions, examines received responses to see if the intentions were carried out, and determines how to interpret the results. The target of an HTTP request is called a “resource.” Additionally or alternatively, a “resource” is an object with a type, associated data, a set of methods that operate on it, and relationships to other resources if applicable. Each resource is identified by at least one Uniform Resource Identifier (URI), and a resource URI identifies at most one resource. Resources are acted upon by the RESTful API using HTTP methods (e.g., POST, GET, PUT, DELETE, etc.). With every HTTP method, one resource URI is passed in the request to address one particular resource. Operations on resources affect the state of the corresponding managed entities.

Considering that a resource could be anything, and that the uniform interface provided by HTTP is similar to a window through which one can observe and act upon such a thing only through the communication of messages to some independent actor on the other side, an abstraction is needed to represent (“take the place of”) the current or desired state of that thing in our communications. That abstraction is called a representation. For the purposes of HTTP, a “representation” is information that is intended to reflect a past, current, or desired state of a given resource, in a format that can be readily communicated via the protocol. A representation comprises a set of representation metadata and a potentially unbounded stream of representation data. Additionally or alternatively, a resource representation is a serialization of a resource state in a particular content format.

As noted above, the following focuses on the problem of registering a first edge application (e.g., a MEC App, as defined by ETSI GS MEC 003, including in ETSI GSME 003: “Multi-access Edge Computing (MEC); Framework and Reference Architecture”, v3.1.1, March 2022, and subsequent versions) and a second application (e.g., an Edge Application Server—EAS, as defined by 3GPP SA6 EDGEAPP specification TS 23.558, including in 3GPP TS 23.558, “Architecture for enabling Edge Applications; (Release 17)”, V17.0.0, June 2021, and subsequent versions) in two systems, such in both of an ETSI MEC Platform and a 3GPP EDGEAPP Edge Enabler Server (EES), without the need to establish separate edge application registrations. Thus, the following removes the need for improved development skills and extended application code to ensure that the edge application is discoverable by both systems (ETSI MEC and 3GPP EDGEAPP systems).

The following techniques provide an improvement to the approaches discussed in ETSI MEC for dual application registration (see MEC(21)000429r2—MEC011-MEC016—ETSI MEC-3GPP EDGEAPP alignment—MEG application dual registration), where the developer opts in for dual edge application registration, which is implemented following a mechanism in an Edge Dual Deployment (EDD) environment. According to MEC(21)000429r2, the edge application developer may select one of the two following (alternative) approaches: (1) choose ETSI MEC as primary architecture and perform a MEC App registration to the ETSI MEC system (where 3GPP EDGEAPP is indicated as secondary system); or (2) choose 3GPP EDGEAPP as primary architecture and perform an EAS registration to the 3GPP EDGEAPP system (where ETSI MEC is indicated as secondary system). Methods and systems for registering an application in each of these approaches are addressed in the following discussion.

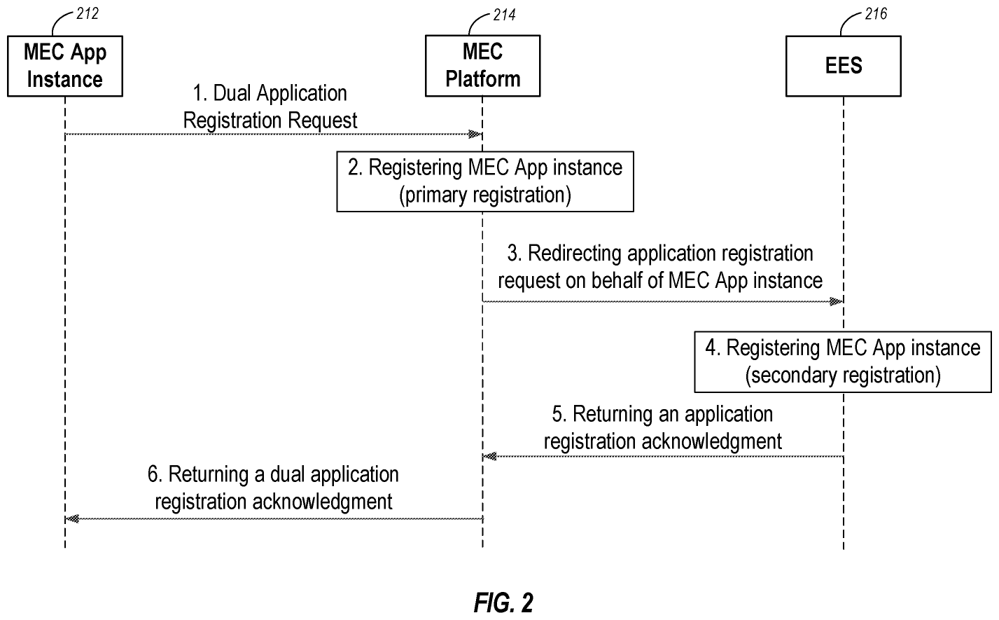

FIG. 2 depicts a scenario for dual registration in the case of an ETSI MEC deployment being used as the primary system. After the dual application registration procedure is accomplished, the edge application (e.g., a MEC App instance 212, as shown in FIG. 2) will be able to directly consume APIs from an ETSI MEC system (e.g., a MEC platform 214 operating as a primary system) and then from a 3GPP system (e.g., an EES 216 operating as a as secondary system) via the respective interfaces:
1) an Mp1 interface (reference point) connecting the MEC Platform 214 to the Edge Application—the Edge Application here provided as a MEC App from the ETSI MEC system; and
2) an EDGE-3 interface connecting the EES 216 to the same Edge Application—the Edge Application provided here as an EAS from the 3GPP system.

Thus, the sequential operations (1) to (6) depicted in FIG. 2 show how a MEC App instance 212 communicates a MEC App registration request to a primary system (IEC platform 214), how the primary system communicates to a secondary system (EES 216), and the return of such registration acknowledgment.

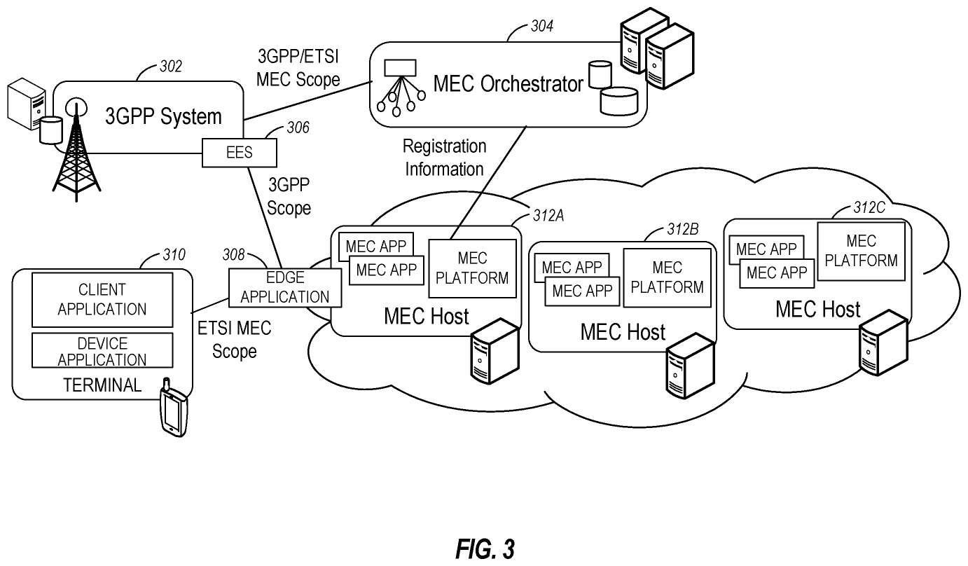

FIG. 3 depicts a deployment instance following dual edge application registration, in the case of an ETSI MEC deployment being used as a primary system. In particular, this deployment instance considers the use of edge applications in the presence of Edge Dual Deployments, i.e. co-existing 3GPP EDGEAPP and ETSI MEC systems.

As shown in FIG. 3, a user terminal 310 (e.g., a user equipment such as a smartphone) connects to an edge application 308 via a ETSI MEC interface. The edge application is provided by an ETSI MEC system using one or more MEC hosts 312A, 312B, 312C, consistent with the architecture discussed with reference to FIGS. 1A and 1B, above.

In the scenario of FIG. 3, however, additional operations are performed by a MEC orchestrator 304 to coordinate registration information from the MEC hosts 312A, 312B, 312C to a 3GPP system 302. The registration information for the edge application 308, for example, may be provided to the 3GPP system 302 for use with the EES 306. This allows dual registration, so that the edge application 308 can use features of the EES 306, and so that the EES 306 can likewise use features of the edge application 308 and the MEC hosts 312A, 312B, 312C.

The disclosure below addresses a variety of technical problems related to application registration and coordination among different types of systems which host applications. First, in case of single edge application registration, a first problem that is solved is how to simplify the single registration procedures from an application developer perspective. This is relevant whether the edge application is registering itself to a 3GPP EES (as an EAS) or to an ETSI MEC platform (as a MEC App instance). Second, in case of dual application registration procedure, a second problem that is solved is how to “hide” to the developer the complexity of the registration to the secondary system (in both cases, 3GPP or ETSI MEC). A related technical issue is how to define a dual registration procedure so that subsequent communication exchanges (i.e., after the registration) can be performed directly between the edge application and the platforms, e.g. for edge service APIs consumption.

For these and related issues, the following solutions are offered. First, for single app registration, the presently disclosed approaches include alignment of MEC App information to an EAS Profile (applicable to both single and dual edge application registration requests), and the use of a MEC App profile “AppProfile” as part of a dual edge application registration request. Second, for dual app registration, the presently disclosed approaches include: 1) definition of specific messages in ETSI MEC/3GPP EDGEAPP and related data types, for dual registration; 2) clarification on how the MEC platform (e.g., using EDGE-3) can be authorized to perform the registration on-behalf of MEC App instance; and 3) specification of the response message, with relevant URI back to the MEC App/EAS requesting dual application registration.

### Overview of Single (Intra-System) Edge Application Registration

The aim of an edge application registration procedure is two-fold: application discovery and application context relocation. This is meant to be intra-system, meaning, the application can be discovered within its own system where it is registered, and also the application context can be relocated within the system (whether in a ETSI MEC or 3GPP system). The single application registration procedure has been specified by both 3GPP SA6 EDGEAPP (e.g., as noted in 3GPP TS 23.558, referring to EAS registration to an EES) and ETSI ISG MEC (e.g., as noted in ETSI GS MEC 011, referring to a MEC App registration to a MEC Platform).

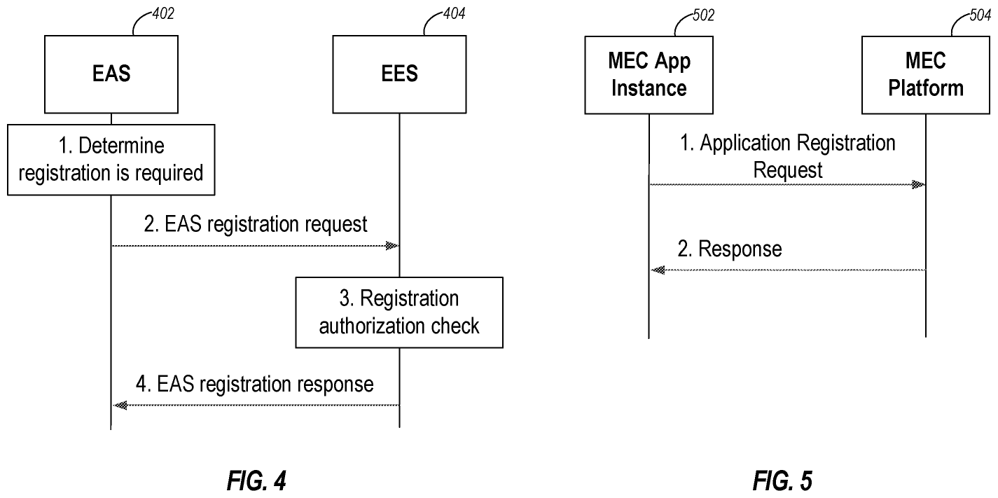

FIG. 4 depicts an EAS registration procedure according to 3GPP specifications. Here, following 3GPP SA6 specifications, as per 3GPP TS 23.558, an EAS 402 registers itself with an EES 404 to allow other entities to discover itself. Because the EAS registration is time limited, an update registration request is required prior to a registration expiration time.

The EDGEAPP architecture defines following information elements to be used during registration, registration update and de-registration of EAS:

TABLE 1
EAS Information Elements for registration, registration
update and de-registration (source: 3GPP TS 23.558).

| Request/ | | | |
|---|---|---|---|
| Response | Information | | |
| Type | element | Status | Description |
| EAS | EAS Profile | M | EAS Profile as described in |
| Registration | | | Table 8.2.4-1 of 3GPP TS |
| | | | 23.558 |
| Request | Security | M | Security credentials of the EAS. |
| | credentials | | |
| | Proposed | O | Proposed expiration time for the |
| | expiration | | registration |
| | time | | |
| EAS | Successful | O | Indicates that the registration |
| Registration | response | | request was successful. |
| Response | > Registration | M | Identifier of the registration. |
| | ID | | |
| | > Expiration | O | Indicates the expiration time of |
| | time | | the registration. To maintain an |
| | | | active registration status, a |
| | | | registration update is required |
| | | | before the expiration time. |
| | | | If the Expiration time IE is not |
| | | | included, it indicates that the |
| | | | registration never expires. |
| | Failure | O | Indicates that the registration |
| | response | | request failed. |
| | > Cause | O | Indicates the cause of |
| | | | registration request failure |
| EAS | Registration | M | Identifier of the registration. |
| Registration | ID | | |
| update | Security | M | Security credentials of the EAS |
| Request | credentials | | |
| | Updated | O | EAS Profile as described in |
| | EAS Profile | | Table 8.2.4-1 with updated |
| | | | information. Included only if |
| | | | there is an update in EAS |
| | | | information. |
| | Proposed | O | Proposed expiration time for the |
| | expiration | | registration |
| | time | | |
| EAS | Successful | O | Indicates that the registration |
| Registration | response | | update request was successful. |
| Update | > Expiration | O | Indicates the expiration time of |
| Response | time | | the updated registration. To |
| | | | maintain an active registration |
| | | | status, a registration update is |
| | | | required before the expiration |
| | | | time. |
| | | | If the Expiration time IE is not |
| | | | included, it indicates that the |
| | | | updated registration never |
| | | | expires. |
| | Failure | O | Indicates that the registration |
| | response | | update request failed. |
| | > Cause | O | Indicates the cause of |
| | | | registration update request |
| | | | failure |
| EAS de- | Registration | M | Identifier of the registration. |
| registration | ID | | |
| Request | Security | M | Security credentials of the EAS |
| | credentials | | |
| EAS de- | Successful | O | Indicates that the de-registration |
| registration | response | | request was successful. |
| Response | Failure | O | Indicates that the de-registration |
| | response | | request failed. |
| | > Cause | O | Indicates the cause of de- |
| | | | registration request failure |

Upon receiving the registration request from the EAS 402, the EES 404 stores EAS profile information to be used during EAS discovery at a later stage. In an example, the EAS profile will contain some or all the information elements described in Table 2:

TABLE 2
List of Information Elements in EAS
Profile (source: 3GPP TS 23.558).

| Information | | |
|---|---|---|
| element | Status | Description |
| EASID | M | The identifier of the EAS |
| EAS | M | Endpoint information (e.g., URI, FQDN, IP |
| Endpoint | | address) used to communicate with the EAS. |
| | | This information maybe discovered by EEC and |
| | | exposed to ACs so that ACs can establish contact |
| | | with the EAS. |
| ACID(s) | O | Identifies the AC(s) that can be served by the |
| | | EAS |
| EAS | O | The identifier of the ASP that provides the EAS. |
| Provider | | |
| Identifier | | |
| EAS Type | O | The category or type of EAS (e.g., V2X) |
| EAS | O | Human-readable description of the EAS |
| description | | |
| EAS | O | The availability schedule of the EAS (e.g., time |
| Schedule | | windows) |
| EAS | O | The geographical service area that the EAS |
| Geographical | | serves. ACs in UEs that are located outside that |
| Service Area | | area shall not be served. |
| EAS | O | The EAS serves UEs that are connected to the |
| Topological | | Core Network from one of the cells included in |
| Service Area | | this service area. ACs in UEs that are located |
| | | outside this area shall not be served. See possible |
| | | formats in Table 8.2.7-1. |
| EAS Service | O | Service characteristics provided by EAS, |
| KPIs | | detailed in Table 8.2.5-1 |
| EAS service | O | Level of service permissions e.g., trial, gold- |
| permission | | class supported by the EAS |
| level | | |
| EAS | O | Service features e.g., single vs. multi-player |
| Feature(s) | | gaming service supported by the EAS |
| EAS Service | O | Indicates if the EAS supports service continuity |
| continuity | | or not. This IE also indicates which ACR |
| support | | scenarios are supported by the EAS. |
| List of EAS | O | DNAI(s) associated with the EAS. This IE is |
| DNAI(s) | | used as Potential Locations of Applications in |
| | | clause 5.6.7 of 3GPP TS 23.501 [2]. |
| | | It is a subset of the DNAI(s) associated with the |
| | | EDN where the EAS resides. |
| List of N6 | O | The No traffic routing information and/or routing |
| Traffic | | profile ID corresponding to each EAS DNAI. |
| Routing | | |
| requirements | | |
| EAS | | The availability reporting period (i.e., heartbeat |
| Availability | | period) that indicates to the EES how often it |
| Reporting | | needs to check the EAS's availability after a |
| Period | | successful registration. |
| EAS | O | A list of the Service APIs that are required by the |
| Required | | EAS |
| Service APIs | | |
| EAS Status | O | The status of the EAS (e.g., enabled, disabled, |
| | | etc.) |

In some examples, the registration techniques discussed herein may be extended to apply to an update or re-registration. Accordingly, a request to register may occur during a request to update or a request to re-register.

Some ETSI GS MEC 011 specifications introduce the procedure of a MEC App registering to a MEC Platform. An application registration procedure allows a MEC application instance to provide its information to the MEC platform.

FIG. 5 shows a scenario where a MEC application instance 502 sends an application registration request to a MEC platform 504. The MEC application registration, as illustrated in FIG. 5, includes the following steps:
1) A MEC application instance 502 sends a request to the MEC platform 504 to register itself.
2) The IEC platform 504 registers the MEC application instance 502 and returns an application registration acknowledgement response.

In this context, “application registration” refers to operations to register a MEC application instance to a platform (e.g., a MEC platform). It will be understood that a similar application registration “update” flow to update an existing MEC application instance registration to the platform, and a similar application “de-registration” flow to cancel or remove an existing MEC application registration to the platform may also be implemented separately or as part of the “application registration”.

As will be apparent from the following discussion, it is possible for a MEC application instance to register to both a MEC platform and an Edge Enabler Server (EES). However, in some scenarios, it is left to implementation details (e.g., to the application developer) to decide if dual application registration is necessary.

### Overview of Dual Edge Application Registration

The goal of a dual edge application registration procedure has multiple aspects: application discovery, application context relocation and (most importantly) consumption of edge service APIs from both platforms (EES and MEC Platform). In an example, the edge application registration request to the secondary system (3GPP EDGEAPP or ETSI MEC) may be provided by: i) the MEC Platform on behalf of the requesting MEC App (towards the EES the MEC App aims to register itself to or by ii) the EES on behalf of the requesting EAS (towards the MEC Platform the EAS aims to register itself to).

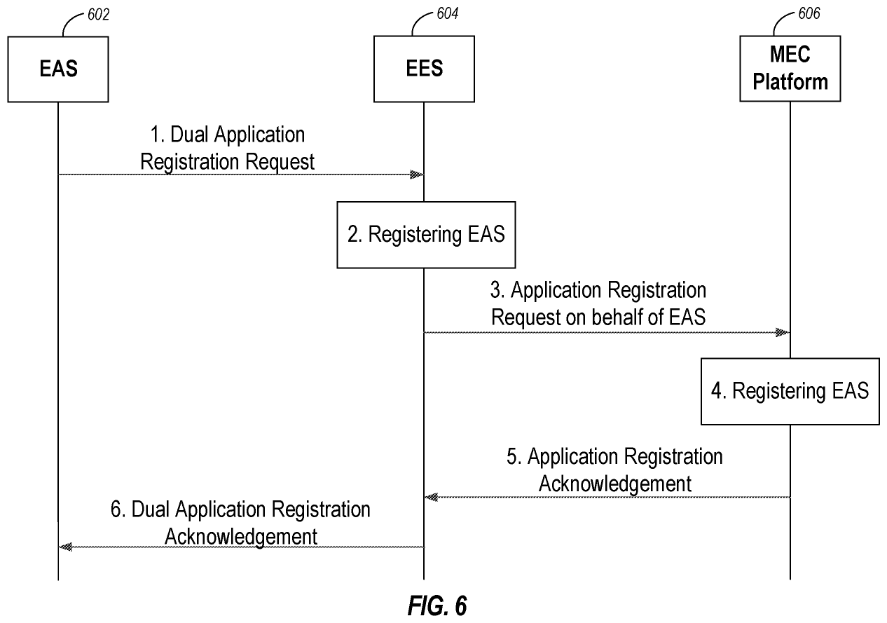

In an example, a technique for dual edge application registration is based on a procedure being triggered by an EAS, as illustrated in FIG. 6 and explained in the following explanatory sequence. Here, the pre-conditions for such application registration include: (i) the EAS has been configured with an EASID; (ii) the EAS has been configured with the address (e.g. URI) of the EES; (iii) both the EAS and EES have the necessary credentials to enable communications; and (iv) EES is aware of MEC Platform and aware of the process to register EAS with MEC platform.

FIG. 6 depicts a dual application registration procedure, in a scenario that is triggered by an EAS. This is depicted in FIG. 6 with the following sequence:
1. An EAS 602 determines that dual application registration to a EES 604 and to a MEC Platform 606 is desired, and the EAS 602 sends a dual application registration request to the EES 604. The request includes the EAS profile and may include a proposed expiration time for the registration.
2. The EES 604 performs an authorization check to verify whether the EAS 602 has the authorization to register on the EES 604. After the verification, the EES 604 registers the EAS 602.
3, The EES 604 sends an application registration request on behalf of the EAS 602 to the MEC platform 606. The EES 604 may use a Mp1 interface (reference point) to register with the MEC Platform 606.
4. The MEC Platform 606 performs the authorization check and registers the EAS 602.
5. Upon successful registration, the MEC Platform 606 responds with an application registration response to the EES 604.
6. The EES 604 in turn responds with an EAS dual registration response to the EAS 602, including a URI of the MEC platform 606. This will allow the EAS 602 to invoke APIs from the two platforms independently.

With respect to single edge application registration, currently available approaches do not enable the edge application (MEC App or EAS) to be discoverable across 3GPP EDGEAPP and ETSI MEC systems, regardless of the deployment option (i.e., the EES being collocated with a MEC Platform as part of the same edge cloud hardware entity or not). One approach to overcome this issue would be for the edge application to perform two distinct (or, independent) application registration procedures, one per system.

For dual edge application (MEC App or EAS) registration procedures, one unresolved issue is that when performing edge application registration to the secondary system (registration “on-behalf of the requesting edge application”), the platform receiving this request needs to comprehend the request's payload/message body. More specifically, this raises the following use cases:

In a use case where an EAS triggers the dual application registration request, one issue is how the EAS Profile (which is mandatorily needed as part of registration request to the EES in state-of-the-art EAS registration to EES, e.g., as defined in 3GPP TS 23.588) could be comprehended by the MEC Platform. This profile is needed in order to correctly perform the EAS registration to the secondary system (ETSI MEC Platform).

Additionally, as in 3GPP TS 23.558, an EES needs to obtain an EAS registration request including the EAS Profile. MEC App information needed to accompany the registration request will be comprehended by the (targeted) EES during application registration to the secondary (3GPP EDGEAPP) system.

As a result, to ensure that all steps of the dual edge application registration procedure are performed seamlessly across the two systems, an alignment between the data structure containing the MEC App information and an EAS Profile needs to be performed. This alignment is discussed in more detail in the following paragraphs. As will be understood, this alignment can be realized if the registration “on-behalf of the requesting edge application” is an authorized procedure from the entity receiving that request, e.g. a MEC Platform or an EES supports and authorizes dual registration. The present disclosure also includes mechanisms to authorize the primary system toward the secondary system to perform the registration on-behalf of the calling entity (MEC App or EAS).

In the following, considerations are made for edge applications in presence of Edge Dual Deployments, i.e. 3GPP EDGEAPP and ETSI MEC systems. The following aims to address the following open problems with existing approaches.

First, in case of single edge application registration, one problem that is addressed is how to simplify the single registration procedures from an application developer perspective. This is relevant whether the edge application is registering itself to a 3GPP EES (as an EAS) or to an ETSI MEC platform (as a MEC App instance).

For single app registration, the following discusses an alignment of MEC App information to an EAS Profile (applicable to both single and dual edge application registration requests) and use of MEC App profile “AppProfile” as part of a dual edge application registration request.

Second, in case of dual application registration procedures, another problem that is addressed is how to hide the complexity of the registration to the secondary system (in both cases, 3GPP or ETSI MEC), to a developer or user. This is related to the issue of how to define a dual registration procedure so that subsequent communication exchanges (i.e., after the registration) can be performed directly between the edge application and the platforms, e.g. for edge service APIs consumption.

For dual app registration the following discusses a definition of specific messages in ETSI MEC/3GPP EDGEAPP and related data types, for dual registration. Further, the following provides clarification on how a MEC platform (e.g., using EDGE-3) can be authorized to perform the registration on-behalf of MEC App instance. Additionally, the following provides a specification of a response message, providing a relevant URI back to the MEC App/EAS requesting dual application registration.

The following also facilitates the alignment of ETSI MEC and 3GPP standards on edge computing, thus enabling a smoother usage of products implementing them, so that a single application can consume services from the two systems. This will avoid fragmentation and foster collaboration among heterogeneous partners (e.g. implementing solutions compliant with single standards), increasing the adoption of ETSI MEC.

The following also introduces a scheme proposed to align the MEC App information to be used as part of a MEC App registration request, single or dual, to an EAS Profile (or, the opposite, depending on the origin of dual edge application registration request). Based on this alignment scheme, the following defines proper messages among systems, both in ETSI MEC and 3GPP standards, with respect to dual application registration. In case of dual deployments, the solution will need to be included by all 3GPP EDGEAPP and ETSI MEC reference implementations of these products. Additionally, a further motivation for dual deployments is the introduction of MEC Federations, by GSMA OP-compliant products).

The following also introduces a MEC App profile/EAS Profile alignment scheme as part of a dual application registration procedure. This registration procedure not only involves internal messages (within a ETSI MEC system or a 3GPP SA6 EDGEAPP system) but also external/cross-system messages (involving the edge application deployed in a dual mode).

Cross-System Edge Application Registration. The overall cross-system edge application registration scenario can be decomposed to the following sub-problems:

Problem #1: in the case of single edge application registration, the aim is to simplify the single registration procedures from an application developer perspective, no matter if the edge application is registering itself to a 3GPP EES (as an EAS) or to an ETSI MEC platform (as a MEC App instance).

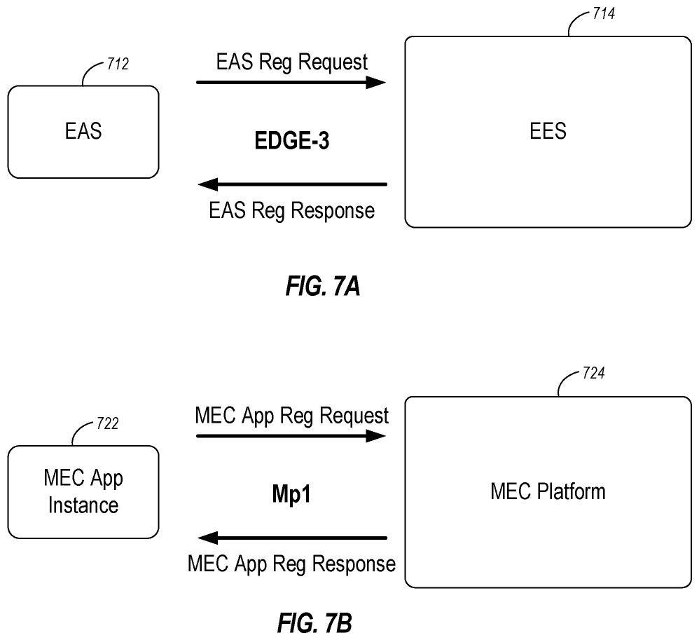

FIG. 7A depicts a first use case of a single edge application registration to a 3GPP system. Here, this use case involves registration of an EAS 712 to an EES 714, using request and response messages via EDGE-3. This registration may be performed according to 3GPP specifications.

FIG. 7B depicts a second use case of a single edge application registration to an ETSI MEC system. Here, this use case involves registration of a MEC App instance 722 to a MEC Platform 724. In this context, the following disclosure introduces a data type characterizing a MEC App (e.g., a MEC App Profile) in a way that it is aligned with the 3GPP procedures (e.g., the counterpart of an EAS Profile, as specified in TS 23.558). Specifically, this focuses on the scenario of registration of an “already instantiated” MEC App (e.g., registration of the MEC App instance 722). In some examples, a single MEC App instance registration to a MEC Platform may take place before a dual MEC App instance registration request is raised. Alternatively, dual registration can be performed directly, without the need to first perform single registration.

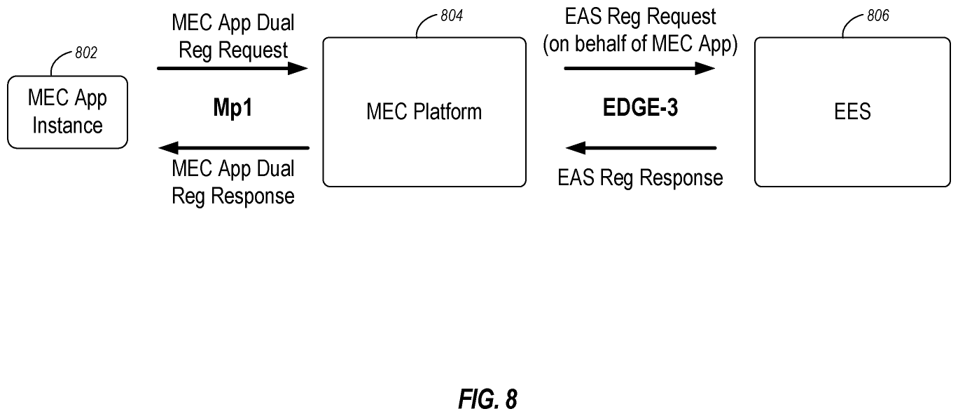

FIG. 8 depicts a third use case of dual edge application registration to both systems. Here, this use case involves a MEC App instance 802 acting as a triggering entity of a dual edge application registration, indicating a ETSI MEC system (e.g., a MEC platform 804) as a primary system and a 3GPP EDGEAPP system (e.g., EES 806) as a secondary system. It will be understood that FIG. 8 is merely one example of the registration in one direction from an ETSI MEC system to a 3GPP EDGEAPP system; the registration techniques discussed herein are equally applicable to a registration triggered from the 3GPP EDGEAPP system (as the primary system) where the ETSI MEC system operates as the receiving system (as the secondary system).

In this context of dual 3GPP EDGEAPP and ETSI MEC systems, an open issue is how to “hide” to the developer the complexity of the registration to the secondary system (in both cases, 3GPP or ETSI MEC), and define a dual registration procedure so that subsequent communication exchanges (i.e., after the registration) can be performed directly between the edge application and the platforms, e.g. for edge service APIs consumption. In order to address dual edge application registration the following actions and messages are considered. First, Specific messages are needed in ETSI MEC involving related data types for dual registration. Second, clarification is needed on how the MEC platform (using EDGE-3 interface) can be authorized to perform the secondary registration (to an EES) on-behalf of the requesting MEC App instance. Third, a proper EES response message needs to be defined, with relevant URI (i.e., communication endpoint), that is sent to the MEC Platform, and relayed back to the MEC App instance. The following proposes approaches to address each of these use cases.

### Aligning MEC App Information to an EAS Profile (Applicable to Both Single and Dual Edge Application Registration Requests)

The following proposes the addition of a MEC App profile and the corresponding new data structure AppProfile for use with ETSI MEC systems, which will be used in the message body of a MEC App registration request (whether a single registration to a MEC Platform or a dual registration to a MEC Platform and an EES). The attributes of the AppProfile data structure have a one-to-one correspondence (in terms of cardinality and data type) to the attributes of the EAS Profile data structure, as the latter is specified in 3GPP TS 23.558 and are mostly inherited from the AppD and AppInstanceInfo data structures, as specified in ETSI GS MEC 010-2 (e.g., ETSI GS MEC 010-2: “Multi-access Edge Computing (MEC); MEG Management; Part 2: Application lifecycle, rules and requirements management”, v2.1.16 (draft), October 2021) The proposed data structure appears in Table 3, as follows.

TABLE 3
Attributes of AppProfile

| Attribute | | Data | |
|---|---|---|---|
| name | Cardinality | type | Description |
| id | 1 | String | Identifier of the MEC |
| | | | application instance represented |
| | | | by this data type. |
| _links | 1 | Structure | Links to resources related to this |
| | | (inlined) | resource. |
| >self | 1 | LinkType | Self referring URI. |
| clientApp | 0 . . . 1 | String | Identifies the client applications |
| | | | that can be served by the MEC |
| | | | application instance. |
| appProvider | 0 . . . 1 | String | The onboarded application |
| | | | package provider name. |
| appType | 0 . . . 1 | String | The category or type of MEC |
| | | | application (e.g., V2X) |
| appInstance | 0 . . . 1 | String | Human-readable description of |
| Description | | | the MEC application instance. |
| appSchedule | 0 . . . 1 | Time | The availability schedule of the |
| | | Stamp | MEC application instance. |
| appGeoServ | 0 . . . 1 | Structure | The geographical service area |
| Area | | (inlined) | that the MEC application |
| | | | instance serves. Client |
| | | | applications in UEs that are |
| | | | located outside that area shall |
| | | | not be served. |
| >latitude | 1 | Float | Latitude (DATUM = WGS84) −90 |
| | | | to 90 in decimal degree format DDD.ddd |
| >longitude | 1 | Float | Longitude (DATUM = WGS84) −180 |
| | | | to 180 in decimal degree format DDD.ddd |
| appTopServ | 0 . . . N | CellId | The MEC application instance |
| Area | | | serves UEs that are connected to |
| | | | the Core Network from one of |
| | | | the cells included in this service |
| | | | area. Client applications in UEs |
| | | | that are located outside this area |
| | | | shall not be served. |
| AppService | 0 . . . 1 | Service | Service characteristics provided |
| Kpis | | Kpis | by MEC application instance. |
| App | 0 . . . 1 | String | Level of service permissions |
| Permission | | | e.g., trial, gold-class supported |
| Type | | | by the MEC application |
| | | | instance. |
| appFeatures | 0 . . . N | Feature | Service features e.g., single vs. |
| | | Support | multi-player gaming service |
| | | | supported by the EAS |
| serviceCont | 0 . . . 1 | service | Indicates if the MEC application |
| Support | | Cont | instance supports service |
| | | Support | continuity or not. This attribute |
| | | | also indicates which ACR |
| | | | scenarios are supported by the |
| | | | MEC application instance. |
| appInst | 0 . . . N | Location | Potential locations of MEC |
| Location | | Information | application instance. |
| trafficRouting | 0 . . . 1 | String | The N6 traffic routing |
| Requirements | | | information and/or routing |
| | | | profile ID corresponding to each |
| | | | MEC application instance's Data |
| | | | Network Access Identifier. |
| appAvail | 0 . . . 1 | Time | The availability reporting period |
| Reporting | | Stamp | (i.e., heartbeat period) that |
| Period | | | indicates to the MEC platform |
| | | | how often it needs to check the |
| | | | MEC application instance's |
| | | | availability after a successful |
| | | | registration. |
| appService | 0 . . . N | Service | A list of the service APIs that |
| Required | | Dependency | are required by the MEC application. |
| appStatus | 0 . . . 1 | String | The status of the MEC application |
| | | | instance (e.g., enabled, disabled, |
| | | | etc.). |

In addition to the referenced structured data types specified in ETSI GS MEC 010-2, additional data types, such as ServiceKpis, FeatureSupport, and ServiceContSupport can be defined similarly to counterparts in TS 23.558.

In the various examples discussed herein, this MEC App profile “AppProfile”, as outlined above, may be incorporated into various types of dual edge application registration requests. The proposed data structure AppProfile can be used by an application developer for either single or dual MEC App registration. This data structure is also useable within a MEC system, e.g., for LCM or for aligning with existing data structures (e.g. AppD). For instance, when performing single application registration, a relevant subcase may include registration of an already instantiated MEC App (per current ETSI MEC procedures), where the MEC App has been previously instantiated (via OSS or device app).

Additionally, in the various examples discussed herein, the MEC App profile may be defined according to that specified in ETSI GS MEC 011, with the use of the “AppInfo” data type. Here, this data type represents the information provided by the MEC application instance as part of the “application registration request” and “application registration update” messages discussed above (e.g., with reference to FIG. 5).

The attributes of the AppInfo data type may include the following, adapted from Table 7.1.2.6-1 of ETSI GS MEC 011:

TABLE 3
Attributes of AppInfo

| Attribute | | | |
|---|---|---|---|
| name | Data type | Cardinality | Description |
| appName | String | 1 | Name of the application, e.g., to |
| | | | be consistent with the appName |
| | | | in the AppD, if an AppD is |
| | | | available. |
| appProvider | String | 0 . . . 1 | Provider of the application, e.g., |
| | | | to be consistent with the |
| | | | appProvider in the AppD, if an |
| | | | AppD is available. |
| appCategory | CategoryRef | 0 . . . 1 | Category of the application. |
| appDId | String | 0 . . . 1 | The application descriptor |
| | | | identifier. Managed by the |
| | | | application provider to identify |
| | | | the application descriptor in a |
| | | | globally unique way. This |
| | | | identifier is present if the |
| | | | application instance is |
| | | | instantiated by the MEC |
| | | | Management. |
| appInstance | String | 0 . . . 1 | Identifier of the application |
| Id | | | instance. This identifier is |
| | | | present if the application |
| | | | instance is instantiated by the |
| | | | MEC Management. |
| endpoint | EndPointInfo | 0 . . . 1 | Endpoint information (e.g., |
| | | | URI, FQDN, IP address) of the |
| | | | application server, which is part |
| | | | of the application functionalities. |
| | | | This identifier is present when |
| | | | isInsByMec is FALSE. |
| appService | ServiceDependency | 0 . . . N | Describes services a MEC |
| Required | | | application requires to run. |
| | | | ServiceDependency is defined |
| | | | in ETSI GS MEC 010-2. This |
| | | | value is not provided if an |
| | | | AppD is available. |
| appService | ServiceDependency | 0 . . . N | Describes services a MEC |
| Optional | | | application may use if |
| | | | available. ServiceDependency |
| | | | may be defined according to |
| | | | ETSI GS MEC 010-2. This |
| | | | value is not provided if an |
| | | | AppD is available. |
| appFeature | FeatureDependency | 0 . . . N | Describes features a MEC |
| Required | | | application requires to run. |
| | | | FeatureDependency may be |
| | | | defined according to ETSI GS |
| | | | MEC 010-2. This value is not |
| | | | provided if an AppD is available. |
| appFeature | FeatureDependency | 0 . . . N | Describes features a MEC |
| Optional | | | application may use if |
| | | | available. FeatureDependency |
| | | | may be defined according to |
| | | | ETSI GS MEC 010-2. This |
| | | | value is not provided if an |
| | | | AppD is available. |
| isInsByMec | Boolean | 0 . . . 1 | Indicate whether the application |
| | | | instance is instantiated by the |
| | | | MEC Management. |
| | | | Default to FALSE if absent. |
| appProfile | AppProfile | 0 . . . 1 | Can be mapped to EAS profile |
| | | | as defined in 3GPP TS 29.558. |

In further examples, data provided by AppInfo may be reconciled or made consistent with information from an EAS profile data type.

Specific messages and messaging sequences for use in ETSI MEC/3GPP EDGEAPP and related implementations, for dual registration, are defined as follows:

1) Dual Registration of a MEC App to a MEC Platform (Primary, Direct) and an EES (Secondary. By the MEC Platform on Behalf of the MEC App)

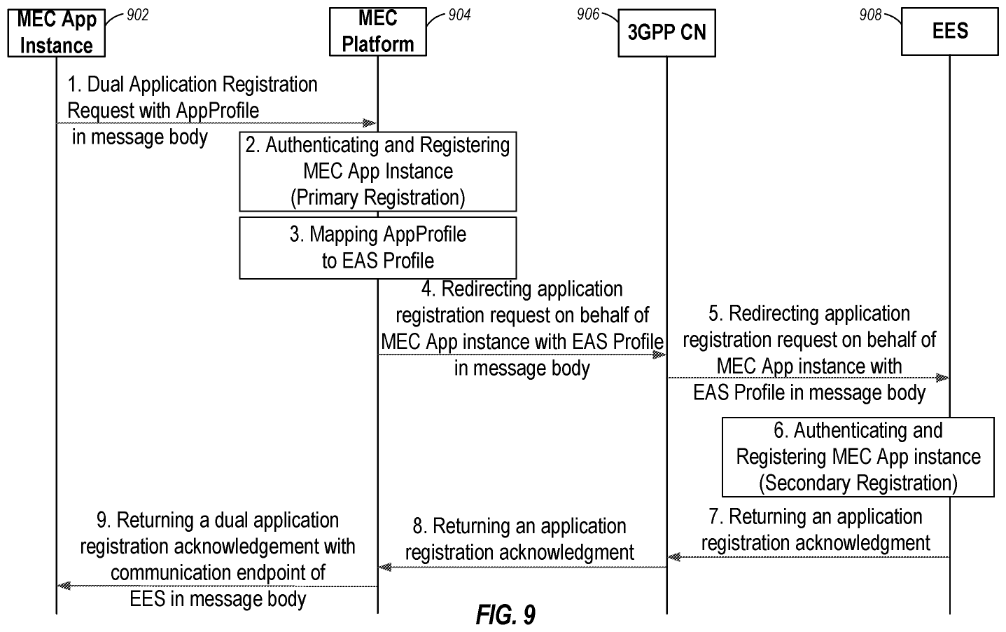

FIG. 9 depicts a MEC App dual application registration sequence. In a first example of dual registration, the MEC App requesting a dual application registration will forward the secondary registration request to the MEC Platform where the App is has primarily registered itself. The MEC Platform can then act as a 3GPP Application Function (AF), including in scenarios when the EES and MEC Platform belong to different trust domains. The interaction between an AF and the 3GPP CN is specified; an AF can directly access 3GPP CN entities via (or without) the NEF.

An example sequence of dual registration “on behalf of the MEC App” includes the following:
1) A MEC App instance 902 issues a dual application registration request with AppProfile in its message body.
2) A MEC Platform 904 authenticates and registers the MEC App instance 902 (performing a primary registration).
3) The MEC Platform 904 performs mapping of AppProfile to EAS Profile.
4) The MEC Platform 904 (playing the role of a 3GPP AF) redirects the application registration request on behalf of the MEC App instance 902 with EAS Profile in its message body to a 3GPP CN 906 (e.g., via the NEF interface).
5) The 3GPP CN 906 redirects application registration request to an EES 908.
6) The EES 908 authenticates and registers the MEC App instance 902 (performing a secondary registration).
7) The EES 908 returns an application registration acknowledgement to the 3GPP CN 906.
8) The 3GPP CN 906 returns the application registration acknowledgement to the MEC Platform 904.
9) The MEC Platform 904 returns the dual application registration acknowledgement to the requesting MEC App instance 902 with communication endpoint of the EES 908 in its message body.

This procedure is applicable to different deployments, whether the same or different Edge Data Networks (EDNs), and whether the same or different trust domains. Here, a direct reference point connecting an EES to a MEP is not needed. However, a prerequisite is for the 3GPP EDGEAPP system to have provided the communication endpoints of its EESs to the MEC Platform (operating on behalf of the MEC App) for EES selection.

### 2) Dual Application Registration of an EAS to an EES (Primary, Direct) and a MEC Platform (Secondary, by the EES on Behalf of the EAS)

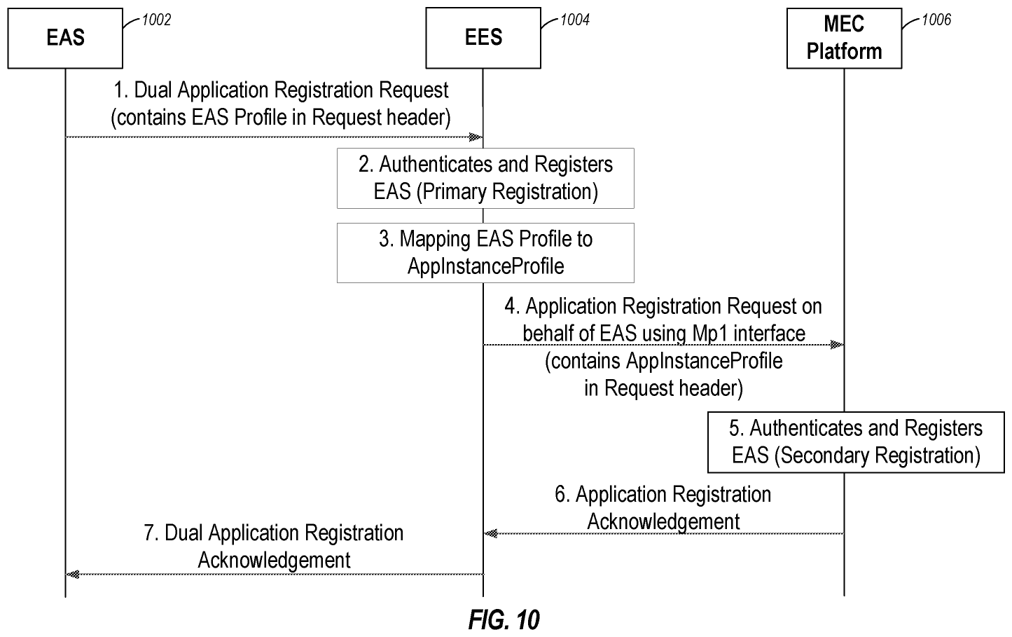

FIG. 10 depicts an EAS dual application registration sequence diagram. In a second example of dual application registration, via an EAS, an EAS 1002 registers with an EES 1004 as a primary or “direct” registration and with a secondary or “on-behalf” registration with a MEC Platform 1006 by the EES 1004 on behalf of the EAS 1002. This will allow the EAS 1002 to invoke APIs directly from both with the platforms.

An example sequence of dual registration with the two platforms includes the following:
1) The EAS 1002 sends out a registration request to the EES 1004 with an intent for dual registration.
2) The EES 1004 authenticates the EAS 1002 and the EAS 1002 registers with the EES 1004 (e.g., using a standard procedure as specified by 3GPP TS 23.558 or another 3GPP standard).
3) The EES 1004 converts the EAS profile into a corresponding AppProfile.
4) The EES 1004 sends the registration (single) request to the MEC Platform 1006 using an Mp1 interface (reference point). The EES 1004 uses the AppProfile derived from an EAS Profile (in Step 3 above).
5) The MEC Platform 1006 authenticates the incoming (single) registration request and registers the EAS 1002 as the secondary registration.
6) The MEC Platform 1006 returns the registration acknowledgement to the EES 1004 accordingly.
7) The EES 1004 returns the dual application registration acknowledgement to the EAS 1002.

In this context, primary registration must be successful even though secondary registration might have failed. The LCM of an application is maintained by the primary registration platform.

3) Response Message with Relevant URI Returned to a MEC App or EAS Requesting Dual Application Registration

As explained above, a dual registration procedure is needed so that subsequent communication exchanges (i.e., after the registration) can be performed directly between the edge application and the platforms, e.g. for edge service APIs consumption. As a consequence, after the dual registration procedure, the edge application should be able to communicate autonomously with both the platforms. In terms of exchanging information upon the involved communication endpoints (i.e., Uniform Resource identifiers—URIs), the following considerations will apply.

First, consider a dual edge application registration request originating from a MEC App (e.g., ETSI MEC is the primary system, and 3GPP EDGEAPP is the secondary system). In this scenario, the following communication endpoints need to be known:

Communication endpoint of the calling MEC App (indicated by the “self” sub-attribute of the proposed AppProfile data structure) as part of the request including the AppProfile data structure in the message body of the request to the MEC Platform. This information can be included in the value of attribute EAS Endpoint of EAS Profile, after the MEC Platform has converted the AppProfile to an EAS Profile.

Communication endpoint of the EES that the MEC App has requested to register itself to (represented by the MEC Platform). This information can be included in the message body of the secondary registration acknowledgement response from the EES (via the MEC Platform) back to the calling MEC App instance.

Second, consider a dual edge application registration request originating from an EAS (e.g., 3GPP EDGEAPP is the primary system, ETSI MEC is the secondary system). In this scenario, the following communication endpoints need to be known:

Communication endpoint of the calling EAS (indicated by the “EAS Endpoint” attribute of the EAS Profile—as specified by TS 23.558), as part of the request including the EAS Profile data structure in the message body of the request to the EES. This information can be included in the value of sub-attribute “self” of AppProfile, after the EES has converted the EAS Profile to an AppProfile.

Communication endpoint of the MEC Platform, that the EAS has requested to register itself to (represented by the EES). This information can be included in the message body of the secondary registration acknowledgement response from the EES back to the calling EAS.

The techniques provided herein are further applicable to the following collocated and non-collocated deployment scenarios.

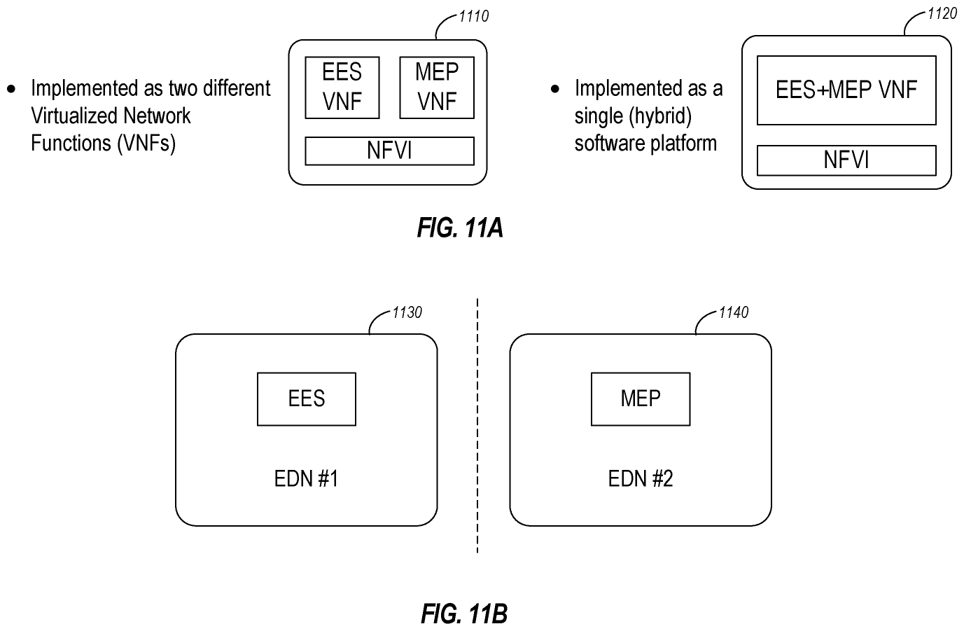

FIG. 11A depicts a co-located platform deployment scenario. Here, the two platforms (i.e., EES and MEC Platform) are co-located on a system, and made by a single (unique) equipment, which is compliant with both standards. In a first flavor (system 1110), the two platforms are implemented as two different Virtualized Network Functions (VNFs) deployed at the same equipment. In a second flavor of co-location (system 1120), the two platforms are co-located and even coincide with the same (hybrid) software platform, which can be practically an AF (realized as a VNF) compliant with both standards.

FIG. 11B depicts a non-co-located platform deployment scenario. Here, the two platforms 1130, 1140 are not co-located, and reside in two different data networks, where the ETSI MEC platform is outside of the Mobile Network Operator (MNO) domain. A similar flavor this deployment may include a scenario where the two platforms (i.e., EES and MEC Platform) are non-collocated, and both residing both within the same trusted domain; however, it might not be very meaningful for an MNO to duplicate its edge infrastructure with a EDGEAPP system and a ETSI MEC system both deployed within the same MNO network. Rather, MNOs may collaborate with hyperscalers and other partners, but these infrastructures are outside of the MNO's trusted domain.

Further extensions of the present techniques may include alignment with other standards and interfaces, including the 3GPP CAPIF (Common API Framework). Likewise, further extensions of the present techniques may include integration with 3GPP standards which align the use of a 3GPP EDGEAPP with ETSI MEC application instances and application information (such as, matching the EAS profile to the Appinfo used in an ETSI MEC system). Accordingly, the data structures, communications, and other procedures discussed above may be adapted for use in related implementations.

### Implementation in Example Methods and Computing Systems

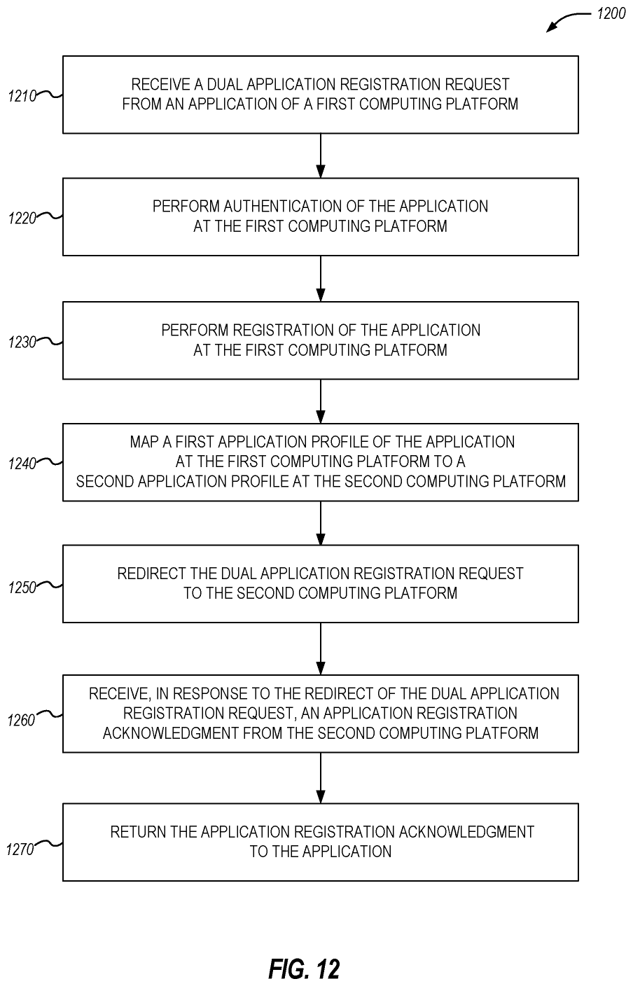

FIG. 12 depicts a flowchart 1200 of a method for performing a dual application registration request with one or multiple platforms. This method is depicted from the perspective of a first computing platform (e.g., a MEC Platform 904 as depicted in FIG. 9, or an EES 1004 as depicted in FIG. 10), which coordinates dual application with a second computing platform (e.g., an EES 908 as depicted in FIG. 9, or a MEC Platform 1006 as depicted in FIG. 10). However, it will be understood that other perspectives and operations may also be involved.

At 1210, operations are performed to receive a dual application registration request from an application of the first computing platform. The dual application registration request received from the application includes may include a first application profile (to be mapped at 1240, discussed below). In a first example, the first computing platform is provided by a Multi-access Edge Computing (MEC) Platform, where the second computing platform is provided by an Edge Enabler Server (EES), and where the application is a MEC application instance operating in the MEC Platform. For instance, such a MEC Platform may operate in a MEC system according to a European Telecommunications Standards Institute (ETSI) MEC specification. In a second example, the first computing platform is provided by an Edge Enabler Server (EES), where the second computing platform is provided by a Multi-access Edge Computing (MEC) Platform, where the application is an application instance operating an Edge Application Server (EAS), and where the dual application registration request includes data for the first application profile. For instance, the EES and the EAS may operate according to a 3GPP EDGEAPP specification.

At 1220, operations are performed for registration of the application at the first computing platform (or, an update of an existing registration), in response to the dual application registration request. For example, the registration of the application may occur at the first computing platform before redirecting the dual application registration request (discussed below at 1250).

At 1230, operations are performed for authentication of the application at the first computing platform. For example, the authentication of the application may occur at the first computing platform before redirecting the dual application registration request. In response to the redirecting of the dual application registration request to the second computing platform (discussed below at 1250), the second computing platform may additionally perform authentication of the application at the second computing platform.

At 1240, operations are performed to map the first application profile of the application at the first computing platform to a second application profile at a second computing platform.

At 1250, operations are performed to redirect the dual application registration request to the second computing platform. As a first example, in a scenario involving the first computing platform as a MEC Platform, the dual application registration request is redirected to the second computing platform on behalf of a MEC application instance. Also, in this scenario, the redirect of the dual application registration request to the second computing platform may be provided through a Core Network operating according to a 3GPP specification. As a second example, in a scenario involving the first computing platform as an EES, the dual application registration request is redirected to the second computing platform on behalf of the EAS using a Mp1 reference point (interface), and the application registration acknowledgment is generated by the MEC Platform in response to registering the EAS at the MEC Platform.

At 1260, operations are performed to receive, in response to the redirect of the dual application registration request, an application registration acknowledgment (e.g., from the second computing platform).

At 1270, operations are performed to return (e.g., provide, communicate, etc.) the application registration acknowledgment to the application. In an example, the application registration acknowledgment identifies a communication endpoint of the second computing platform. As a result of this dual registration, the application may be accessible by a user equipment device on an edge of the network, through use of either the first or the second computing platform.

### Implementation in Edge Computing Scenarios

It will be understood that the present techniques associated with app registration and MEC usage may be integrated with many aspects of edge computing strategies and deployments. Edge computing, at a general level, refers to the transition of compute and storage resources closer to endpoint devices (e.g., consumer computing devices, user equipment, etc.) to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

In the context of satellite communication networks, edge computing operations may occur, as discussed above, by moving workloads onto compute equipment at satellite vehicles; using satellite connections to offer backup or (redundant) links and connections to lower-latency services; coordinating workload processing operations at terrestrial access points or base stations; providing data and content via satellite networks; and the like. Thus, many of the same edge computing scenarios that are described below for mobile networks and mobile client devices are equally applicable when using a non-terrestrial network.

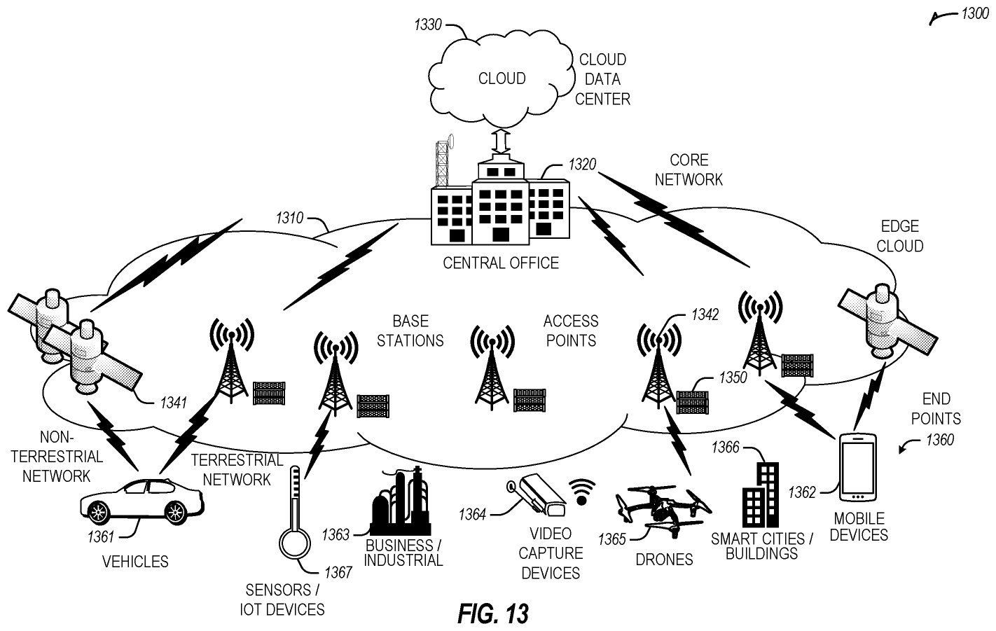

FIG. 13 is a block diagram 1300 showing an overview of a configuration for edge computing, which includes a layer of processing referenced in many of the current examples as an “edge cloud”. This network topology, which may include several conventional networking layers (including those not shown herein), may be extended through the use of the satellite and non-terrestrial network communication arrangements discussed herein.

As shown, the edge cloud 1310 is co-located at an edge location, such as a satellite vehicle 1341, a base station 1342, a local processing hub 1350, or a central office 1320, and thus may include multiple entities, devices, and equipment instances. The edge cloud 1310 is located much closer to the endpoint (consumer and producer) data sources 1360 (e.g., autonomous vehicles 1361, user equipment 1362, business and industrial equipment 1363, video capture devices 1364, drones 1365, smart cities, and building devices 1366, sensors and IoT devices 1367, etc.) than the cloud data center 1330. Compute, memory, and storage resources which are offered at the edges in the edge cloud 1310 are critical to providing ultra-low or improved latency response times for services and functions used by the endpoint data sources 1360 as well as reduce network backhaul traffic from the edge cloud 1310 toward cloud data center 1330 thus improving energy consumption and overall network usages among other benefits.

Compute, memory, and storage are scarce resources, and generally decrease depending on the edge location (e.g., fewer processing resources being available at consumer end point devices than at a base station or a central office). However, the closer that the edge location is to the endpoint (e.g., UEs), the more that space and power are constrained. Thus, edge computing, as a general design principle, attempts to minimize the number of resources needed for network services, through the distribution of more resources that are located closer both geographically and in-network access time. In the scenario of the non-terrestrial network, distance and latency may be far from the satellite, but data processing may be better accomplished at edge computing hardware in the satellite vehicle rather than requiring additional data connections and network backhaul to and from the cloud.

In an example, an edge cloud architecture extends beyond typical deployment limitations to address restrictions that some network operators or service providers may have in their infrastructures. These include a variety of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Edge computing is a developing paradigm where computing is performed at or closer to the “edge” of a network, typically through the use of a compute platform implemented at base stations, gateways, network routers, or other devices which are much closer to the end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Likewise, within edge computing deployments, there may be scenarios in services in which the compute resource will be “moved” to the data, as well as scenarios in which the data will be “moved” to the compute resource. Or as an example, a base station (or satellite vehicle) compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In contrast to the network architecture of FIG. 13, traditional endpoint (e.g., UE, vehicle-to-vehicle (V2V), vehicle-to-everything (V2X), etc.) applications are reliant on local devices or remote cloud data storage and processing to exchange and coordinate information. A cloud data arrangement allows for long-term data collection and storage but is not optimal for highly time-varying data, such as a collision, traffic light change, etc., and may fail in attempting to meet latency challenges. The extension of satellite capabilities within an edge computing network provides even more possible permutations of managing compute, data, bandwidth, resources, service levels, and the like.

Depending on the real-time requirements in a communications context, a hierarchical structure of data processing and storage nodes may be defined in an edge computing deployment involving satellite connectivity. For example, such a deployment may include local ultra-low-latency processing, regional storage, and processing as well as remote cloud data-center-based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally to meet latency requirements. Higher layer data such as Application Layer data is typically less time-critical and may be stored and processed in a remote cloud data center.

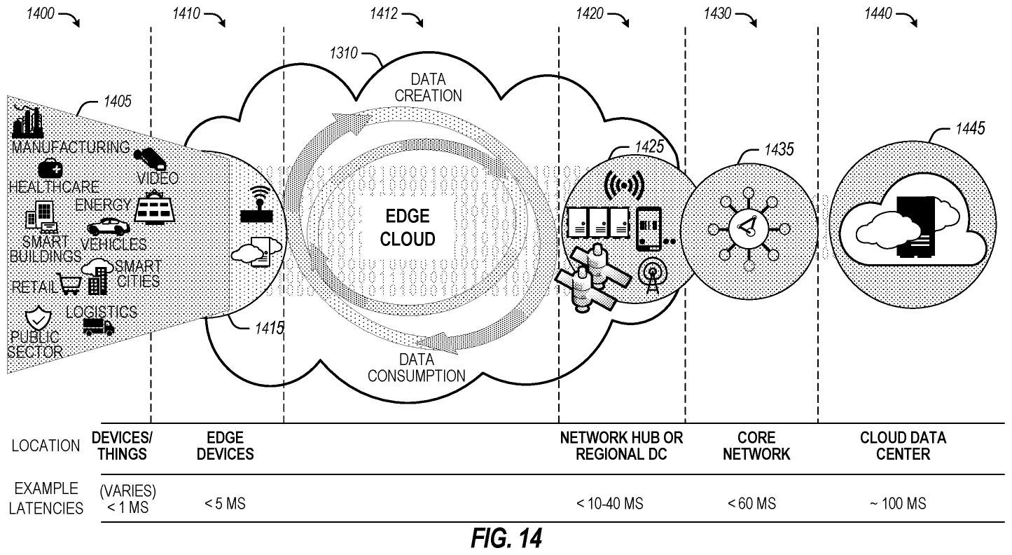

FIG. 14 illustrates operational layers among endpoints, an edge cloud, and cloud computing environments. Specifically, FIG. 14 depicts examples of computational use cases 1405, utilizing the edge cloud 1310 among multiple illustrative layers of network computing. The layers begin at an endpoint (devices and things) layer 1400, which accesses the edge cloud 1310 to conduct data creation, analysis, and data consumption activities. The edge cloud 1310 may span multiple network layers, such as an edge devices layer 1410 having gateways, on-premise servers, or network equipment (nodes 1415) located in physically proximate edge systems; a network access layer 1420, encompassing base stations, radio processing units, network hubs, regional data centers (DC), or local network equipment (equipment 1425); and any equipment, devices, or nodes located therebetween (in layer 1412, not illustrated in detail). The network communications within the edge cloud 1310 and among the various layers may occur via any number of wired or wireless mediums, including via connectivity architectures and technologies not depicted.

Examples of latency with terrestrial networks, resulting from network communication distance and processing time constraints, may range from less than a millisecond (ms) when among the endpoint layer 1400, under 5 ms at the edge devices layer 1410, to even between 10 to 40 ms when communicating with nodes at the network access layer 1420. (Variation to these latencies is expected with the use of non-terrestrial networks). Beyond the edge cloud, 1310 are core network 1430 and cloud data center 1440 layers, each with increasing latency (e.g., between 50-60 ms at the core network layer 1430, to 100 or more ms at the cloud data center layer). As a result, operations at a core network data center 1435 or a cloud data center 1445, with latencies of at least 50 to 100 ms or more, will not be able to accomplish many time-critical functions of the use cases 1405. Each of these latency values is provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1435 or a cloud data center 1445, a central office or content data network may be considered as being located within a “near edge” layer (“near” to the cloud, having high latency values when communicating with the devices and endpoints of the use cases 1405), whereas an access point, base station, on-premise server, or network gateway may be considered as located within a “far edge” layer (“far” from the cloud, having low latency values when communicating with the devices and endpoints of the use cases 1405). It will be understood that other categorizations of a particular network layer as constituting a “close”, “local”, “near”, “middle”, or “far” edge may be based on latency, distance, a number of network hops, or other measurable characteristics, as measured from a source in any of the network layers 1400-1440.

The various use cases 1405 may access resources under usage pressure from incoming streams, due to multiple services utilizing the edge cloud. To achieve results with low latency, the services executed within the edge cloud 1310 balance varying requirements in terms of (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may tolerate an occasional failure, depending on the application); and (c) Physical constraints (e.g., power, cooling, and form-factor).

The end-to-end service view for these use cases involves the concept of a service flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real-time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 1310 may provide the ability to serve and respond to multiple applications of the use cases 1405 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), etc.), which cannot leverage conventional cloud computing due to latency or other limitations. This is especially relevant for applications that require connection via satellite, and the additional latency that trips via satellite would require to the cloud.

However, with the advantages of edge computing come the following caveats. The devices located at the edge are often resource-constrained and therefore there is pressure on the usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 1310 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1310 (network layers 1400-1440), which provide coordination from the client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, circuitry, device, appliance, or other things capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1310.

As such, the edge cloud 1310 is formed from network components and functional features operated by and within edge gateway nodes, edge aggregation nodes, or other edge compute nodes among network layers 1410-1430. The edge cloud 1310 thus may be embodied as any type of network that provides edge computing and/or storage resources that are proximately located to radio access network (RAN) capable endpoint devices (e.g., mobile computing devices, IoT devices, smart devices, etc.), which are discussed herein. In other words, the edge cloud 1310 may be envisioned as an “edge” that connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

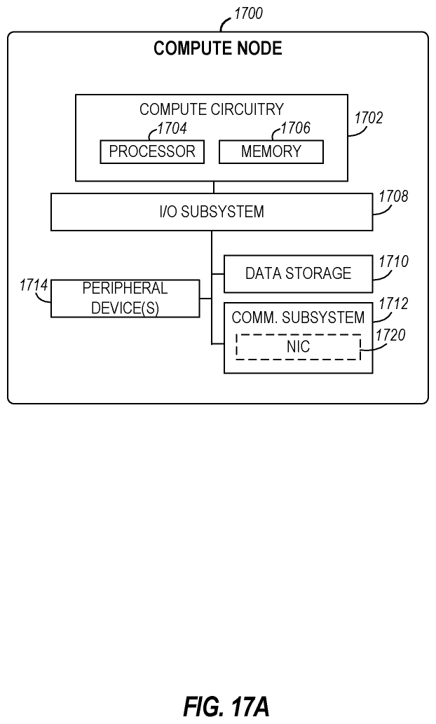

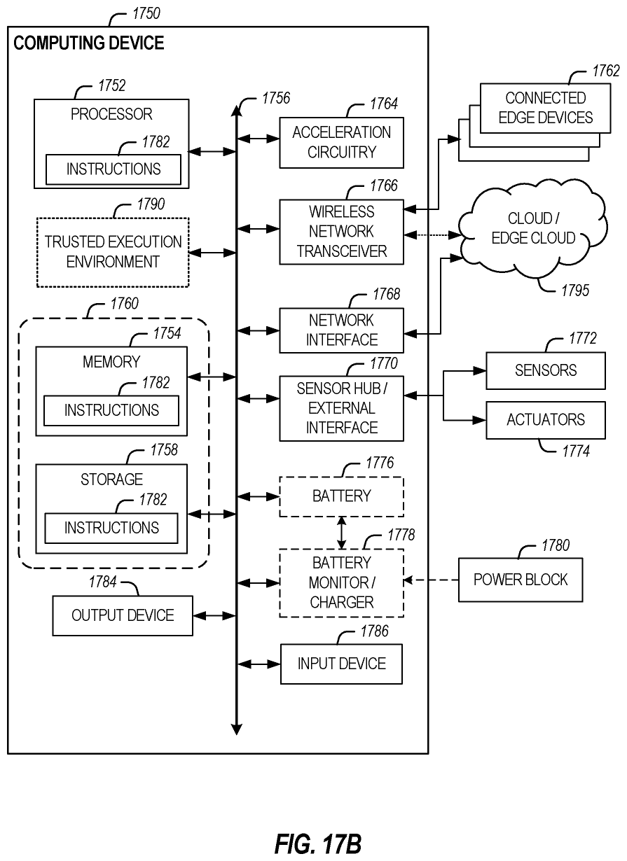

The network components of the edge cloud 1310 may be servers, multi-tenant servers, appliance computing devices, and/or any other type of computing device. For example, a node of the edge cloud 1310 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input device such as user interface hardware (e.g., buttons, switches, dials, sliders, etc.). In some circumstances, example housings include output devices contained in, carried by, embedded therein, and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent of other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 17B. The edge cloud 1310 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code, or scripts may execute while being isolated from one or more other applications, software, code, or scripts.

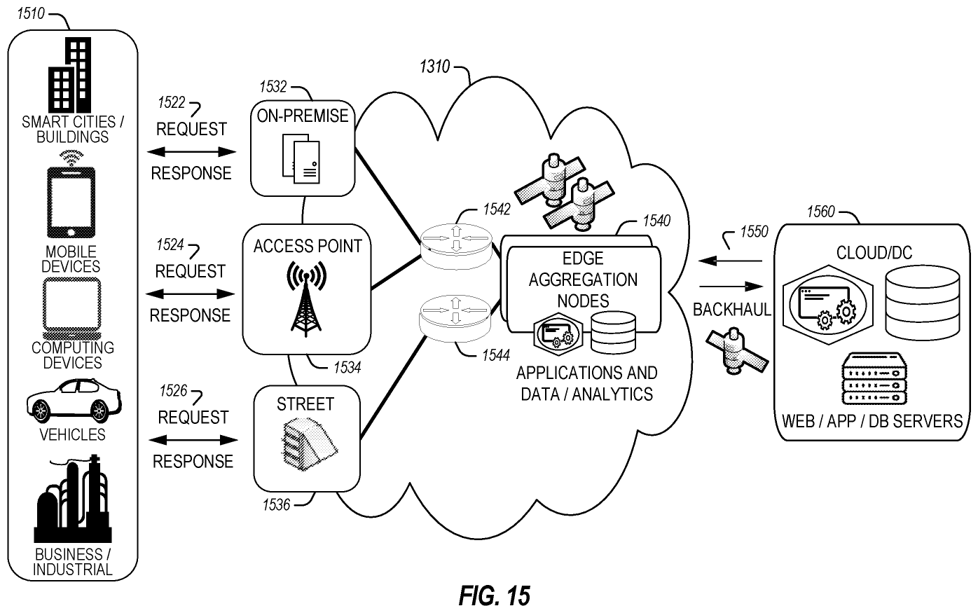

In FIG. 15, various client endpoints 1510 (in the form of mobile devices, computers, autonomous vehicles, business computing equipment, industrial processing equipment) exchange requests and responses that are specific to the type of endpoint network aggregation. For instance, client endpoints 1510 may obtain network access via a wired broadband network, by exchanging requests and responses 1522 through an on-premise network system 1532. Some client endpoints 1510, such as mobile computing devices, may obtain network access via a wireless broadband network, by exchanging requests and responses 1524 through an access point (e.g., cellular network tower) 1534. Some client endpoints 1510, such as autonomous vehicles may obtain network access for requests and responses 1526 via a wireless vehicular network through a street-located network system 1536. However, regardless of the type of network access, the TSP may deploy aggregation points 1542, 1544 within the edge cloud 1310 to aggregate traffic and requests. Thus, within the edge cloud 1310, the TSP may deploy various compute and storage resources, such as at edge aggregation nodes 1540 (including those located at satellite vehicles), to provide requested content. The edge aggregation nodes 1540 and other systems of the edge cloud 1310 are connected to a cloud or data center 1560, which uses a backhaul network 1550 (such as a satellite backhaul) to fulfill higher-latency requests from a cloud/data center for websites, applications, database servers, etc. Additional or consolidated instances of the edge aggregation nodes 1540 and the aggregation points 1542, 1544, including those deployed on a single server framework, may also be present within the edge cloud 1310 or other areas of the TSP infrastructure.

At a more generic level, an edge computing system may be described to encompass any number of deployments operating in the edge cloud 1310, which provide coordination from the client and distributed computing devices. FIG. 14 provides a further abstracted overview of layers of distributed compute deployed among an edge computing environment for purposes of illustration.

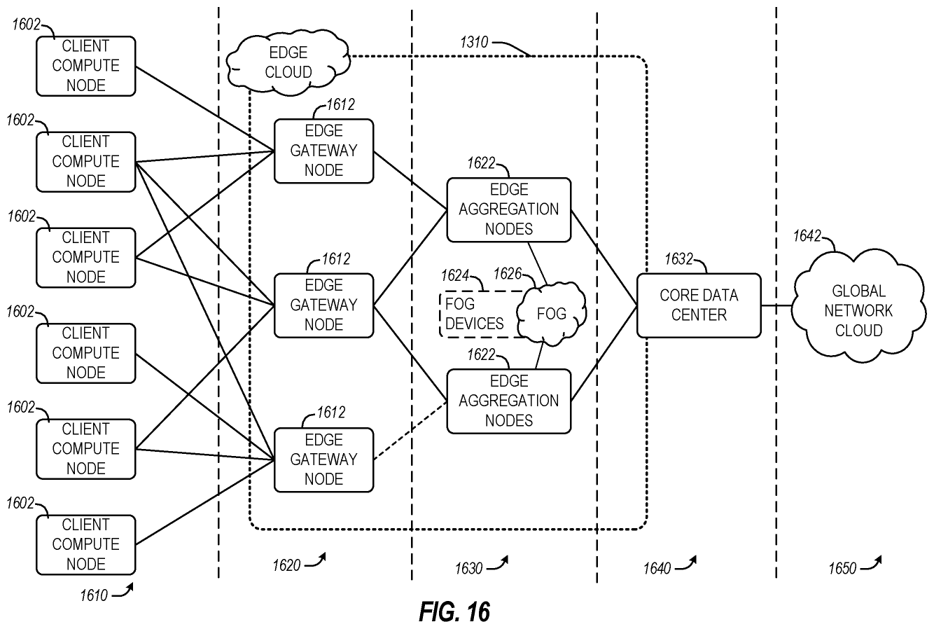

FIG. 16 generically depicts an edge computing system for providing edge services and applications to multi-stakeholder entities, as distributed among one or more client compute nodes 1602, one or more edge gateway nodes 1612, one or more edge aggregation nodes 1622, one or more core data centers 1632, and a global network cloud 1642, as distributed across layers 1610, 1620, 1630, 1640, and 1650 of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer (of layers 1610, 1620, 1630, 1640, and 1650) corresponding to layers 1400, 1410, 1420, 1430, 1440. For example, the client compute nodes 1602 are each located at an endpoint layer 1410, while each of the edge gateway nodes 1612 are located at an edge devices layer 1420 (local level) of the edge computing system. Additionally, each of the edge aggregation nodes 1622 (and/or fog devices 1624, if arranged or operated with or among a fog networking configuration 1626) are located at a network access layer 1430 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of fog may be integrated into an edge computing architecture.

The core data center 1632 is located at a core network layer 1430 (e.g., a regional or geographically-central level), while the global network cloud 1642 is located at a cloud data center layer 1440 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 1632 may be located within, at, or near the edge cloud 1310.

Although an illustrative number of client compute nodes 1602, edge gateway nodes 1612, edge aggregation nodes 1622, core data centers 1632, global network clouds 1642 are shown in FIG. 16, it should be appreciated that the edge computing system may include more or fewer devices or systems at each layer. Additionally, as shown in FIG. 14, the number of components of each layer 1400, 1410, 1420, 1430, 1440 generally increases at each lower level (i.e., when moving closer to endpoints). As such, one edge gateway node 1612 may service multiple client compute nodes 1602, and one edge aggregation node 1622 may service multiple edge gateway nodes 1612.

Consistent with the examples provided herein, each client compute node 1602 may be embodied as any type of end point component, device, appliance, or “thing” capable of communicating as a producer or consumer of data. Further, the label “node” or “device” as used in the edge computing system 1600 does not necessarily mean that such node or device operates in a client or agent/minion/follower role; rather, any of the nodes or devices in the edge computing system 1600 refer to individual entities, nodes, or subsystems which include discrete or connected hardware or software configurations to facilitate or use the edge cloud 1310.

As such, the edge cloud 1310 is formed from network components and functional features operated by and within the edge gateway nodes 1612 and the edge aggregation nodes 1622 of layers 1420, 1430, respectively. The edge cloud 1310 may be embodied as any type of network that provides edge computing and/or storage resources that are proximately located to radio access network (RAN) capable endpoint devices (e.g., mobile computing devices, IoT devices, smart devices, etc.), which are shown in FIG. 14 as the client compute nodes 1602. In other words, the edge cloud 1310 may be envisioned as an “edge” that connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1310 may form a portion of or otherwise provide an ingress point into or across a fog networking configuration 1626 (e.g., a network of fog devices 1624, not shown in detail), which may be embodied as a system-level horizontal and distributed architecture that distributes resources and services to perform a specific function. For instance, a coordinated and distributed network of fog devices 1624 may perform computing, storage, control, or networking aspects in the context of an IoT system arrangement. Other networked, aggregated, and distributed functions may exist in the edge cloud 1310 between the cloud data center layer 1440 and the client endpoints (e.g., client compute nodes 1602). Some of these are discussed in the following sections in the context of network functions or service virtualization, including the use of virtual edges and virtual services which are orchestrated for multiple stakeholders.

The edge gateway nodes 1612 and the edge aggregation nodes 1622 cooperate to provide various edge services and security to the client compute nodes 1602. Furthermore, because each client compute node 1602 may be stationary or mobile, each edge gateway node 1612 may cooperate with other edge gateway devices to propagate presently provided edge services and security as the corresponding client compute node 1602 moves about a region. To do so, each of the edge gateway nodes 1612 and/or edge aggregation nodes 1622 may support multiple tenancies and multiple stakeholder configurations, in which services from (or hosted for) multiple service providers and multiple consumers may be supported and coordinated across a single or multiple compute devices.

In further examples, any of the compute nodes or devices discussed with reference to the present computing systems and environment may be fulfilled based on the components depicted in FIGS. 17A and 17B. Each edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 17A, an edge compute node 1700 includes a compute engine (also referred to herein as “compute circuitry”) 1702, an input/output (I/O) subsystem 1708, data storage 1710, a communication circuitry subsystem 1712, and, optionally, one or more peripheral devices 1714. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1700 may be embodied as any type of engine, device, or collection of devices capable of performing various compute functions. In some examples, the compute node 1700 may be embodied as a single device such as an integrated circuit, an embedded system, a field-programmable gate array (FPGA), a system-on-a-chip (SOC), or other integrated system or device. In the illustrative example, the compute node 1700 includes or is embodied as a processor 1704 and a memory 1706. The processor 1704 may be embodied as any type of processor capable of performing the functions described herein (e.g., executing an application). For example, the processor 1704 may be embodied as a multi-core processor(s), a processing unit, a specialized or special purpose processing unit, a microcontroller, or other processor or processing/controlling circuit. In some examples, the processor 1704 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 1704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized accelerators such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, a SOC, a CPU, and other variations of the processor 1704 may work in coordination with each other to execute many types of operations and instructions within and on behalf of the compute node 1700.

The main memory 1706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte-addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 1706 may be integrated into the processor 1704. The main memory 1706 may store various software and data used during operation such as one or more applications, data operated on by the application(s), libraries, and drivers.

The compute circuitry 1702 is communicatively coupled to other components of the compute node 1700 via the I/O subsystem 1708, which may be embodied as circuitry and/or components to facilitate input/output operations with the compute circuitry 1702 (e.g., with the processor 1704 and/or the main memory 1706) and other components of the compute circuitry 1702. For example, the I/O subsystem 1708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1708 may form a portion of a system-on-a-chip (SoC) and be incorporated, along with one or more of the processor 1704, the main memory 1706, and other components of the compute circuitry 1702, into the compute circuitry 1702.

The one or more illustrative data storage devices 1710 may be embodied as any type of device configured for short-term or long-term storage of data such as, for example, memory devices and circuits, memory cards, hard disk drives, solid-state drives, or other data storage devices. Each data storage device 1710 may include a system partition that stores data and firmware code for the data storage device 1710. Each data storage device 1710 may also include one or more operating system partitions that store data files and executables for operating systems depending on, for example, the type of compute node 1700.

The communication circuitry 1712 may be embodied as any communication circuit, device, or collection thereof, capable of enabling communications over a network between the compute circuitry 1702 and another compute device (e.g., an edge gateway node 1612 of the edge computing system 1400). The communication circuitry 1712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, Matter®, low-power wide-area network (LPWAN) or low-power wide-area (LPWA) protocols, etc.) to effect such communication.

The illustrative communication circuitry 1712 includes a network interface controller (NIC) 1720, which may also be referred to as a host fabric interface (HFI). The NIC 1720 may be embodied as one or more add-in-boards, daughter cards, network interface cards, controller chips, chipsets, or other devices that may be used by the compute node 1700 to connect with another compute device (e.g., an edge gateway node 1612). In some examples, the NIC 1720 may be embodied as part of a system-on-a-chip (SoC) that includes one or more processors or included on a multichip package that also contains one or more processors. In some examples, the NIC 1720 may include a local processor (not shown) and/or a local memory and storage (not shown) that are local to the NIC 1720. In such examples, the local processor of the NIC 1720 (which can include general-purpose accelerators or specific accelerators) may be capable of performing one or more of the functions of the compute circuitry 1702 described herein. Additionally, or alternatively, the local memory of the NIC 1720 may be integrated into one or more components of the client compute node at the board level, socket level, chip level, and/or other levels.

Additionally, in some examples, each compute node 1700 may include one or more peripheral devices 1714. Such peripheral devices 1714 may include any type of peripheral device found in a compute device or server such as audio input devices, a display, other input/output devices, interface devices, and/or other peripheral devices, depending on the particular type of the compute node 1700. In further examples, the compute node 1700 may be embodied by a respective edge compute node in an edge computing system (e.g., client compute node 1602, edge gateway node 1612, edge aggregation node 1622) or like forms of appliances, computers, subsystems, circuitry, or other components.

In a more detailed example, FIG. 17B illustrates a block diagram of an example of components that may be present in an edge computing node 1750 (or similar device) for implementing the techniques (e.g., operations, processes, methods, and methodologies) described herein. The edge computing node 1750 provides a closer view of the respective components of node 1700 when implemented as or as part of a computing device (e.g., as a mobile device, a base station, server, gateway, etc.). The edge computing node 1750 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 1750, or as components otherwise incorporated within a chassis of a larger system.

The edge computing node 1750 may include processing circuitry in the form of a processor 1752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1752 may be a part of a system on a chip (SoC) in which the processor 1752 and other components are formed into a single integrated circuit, or a single package, such as the Edison™ or Galileo™ SoC boards from Intel Corporation, Santa Clara, California. As an example, the processor 1752 may include an Intel® Architecture Core™ based processor, such as a Quark™, an Atom™, a Xeon™, an i3, an i5, an i7, an i9, or an MCU-class processor, or another such processor available from Intel®. However, any number of other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc. The processor 1752 and accompanying circuitry may be provided in a single socket form factor, multiple socket form factor, or a variety of other formats, including in limited hardware configurations or configurations that include fewer than all elements shown in FIG. 17B.

The processor 1752 may communicate with a system memory 1754 over an interconnect 1756 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 1758 may also couple to the processor 1752 via the interconnect 1756. In an example, the storage 1758 may be implemented via a solid-state disk drive (SSDD). Other devices that may be used for the storage 1758 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin-transfer torque (STT)-MPRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low-power implementations, the storage 1758 may be on-die memory or registers associated with the processor 1752. However, in some examples, the storage 1758 may be implemented using a micro hard disk drive (HDD). Further, any number of new technologies may be used for the storage 1758 in addition to, or instead of, the technologies described, such as resistance change memories, phase change memories, holographic memories, or chemical memories, among others.

The components may communicate over the interconnect 1756. The interconnect 1756 may include any number of technologies, including industry-standard architecture (ISA), extended ISA (EISA), peripheral component interconnect (PCI), peripheral component interconnect extended (PCIx), PCI express (PCIe), or any number of other technologies. The interconnect 1756 may be a proprietary bus, for example, used in an SoC-based system. Other bus systems may be included, such as an I2C interface, an SPI interface, point-to-point interfaces, and a power bus, among others.

The interconnect 1756 may couple the processor 1752 to a transceiver 1766, for communications with the connected edge devices 1762. The transceiver 1766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1762. For example, a wireless local area network (WLAN) unit may be used to implement Wi-Fi® communications in accordance with the Institute of Electrical and Electronics Engineers (IEEE) 802.11 standard. Also, wireless wide area communications, e.g., according to a cellular or other wireless wide area protocol, may occur via a wireless wide area network (WWAN) unit.

The wireless network transceiver 1766 (or multiple transceivers) may communicate using multiple standards or radios for communications at a different range. For example, the edge computing node 1750 may communicate with close devices, e.g., within about 10 meters, using a local transceiver based on BLE, or another low power radio, to save power. More distant connected edge devices 1762, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 1766 (e.g., a radio transceiver) may be included to communicate with devices or services in the edge cloud 1795 via local or wide area network protocols. The wireless network transceiver 1766 may be an LPWA transceiver that follows the IEEE 802.15.4, or IEEE 802.15.4g standards, among others. The edge computing node 1750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1766, as described herein. For example, the transceiver 1766 may include a cellular transceiver that uses spread spectrum (SPA/SAS) communications for implementing high-speed communications. Further, any number of other protocols may be used, such as Wi-Fi® networks for medium-speed communications and provision of network communications. The transceiver 1766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1768 may be included to provide a wired communication to nodes of the edge cloud 1795 or other devices, such as the connected edge devices 1762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, Time Sensitive Networks (TSNs), PROFIBUS, or PROFINET, among many others. An additional NIC 1768 may be included to enable connecting to a second network, for example, a first NIC 1768 providing communications to the cloud over Ethernet, and a second NIC 1768 providing communications to other devices over another type of network.

Given the variety of types of applicable communications from the device to another component or network, applicable communications circuitry used by the device may include or be embodied by any one or more of components 1764, 1766, 1768, or 1770. Accordingly, in various examples, applicable means for communicating (e.g., receiving, transmitting, etc.) may be embodied by such communications circuitry.

The edge computing node 1750 may include or be coupled to acceleration circuitry 1764, which may be embodied by one or more AI accelerators, a neural compute stick, neuromorphic hardware, an FPGA, an arrangement of GPUs, an arrangement of xPUs/DPUs/IPU/NPs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1756 may couple the processor 1752 to a sensor hub or external interface 1770 that is used to connect additional devices or subsystems. The devices may include sensors 1772, such as accelerometers, level sensors, flow sensors, optical light sensors, camera sensors, temperature sensors, global navigation system (e.g., GPS) sensors, pressure sensors, barometric pressure sensors, and the like. The hub or interface 1770 further may be used to connect the edge computing node 1750 to actuators 1774, such as power switches, valve actuators, an audible sound generator, a visual warning device, and the like.

In some optional examples, various input/output (I/O) devices may be present within or connected to, the edge computing node 1750. For example, a display or other output device 1784 may be included to show information, such as sensor readings or actuator position. An input device 1786, such as a touch screen or keypad may be included to accept input. An output device 1784 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1776 may power the edge computing node 1750, although, in examples in which the edge computing node 1750 is mounted in a fixed location, it may have a power supply coupled to an electrical grid, or the battery may be used as a backup or for temporary capabilities. The battery 1776 may be a lithium-ion battery, or a metal-air battery, such as a zinc-air battery, an aluminum-air battery, a lithium-air battery, and the like.

A battery monitor/charger 1778 may be included in the edge computing node 1750 to track the state of charge (SoCh) of the battery 1776. The battery monitor/charger 1778 may be used to monitor other parameters of the battery 1776 to provide failure predictions, such as the state of health (Sol) and the state of function (SoF) of the battery 1776. The battery monitor/charger 1778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1778 may communicate the information on the battery 1776 to the processor 1752 over the interconnect 1756. The battery monitor/charger 1778 may also include an analog-to-digital (ADC) converter that enables the processor 1752 to directly monitor the voltage of the battery 1776 or the current flow from the battery 1776. The battery parameters may be used to determine actions that the edge computing node 1750 may perform, such as transmission frequency, mesh network operation, sensing frequency, and the like.

A power block 1780, or other power supply coupled to a grid, may be coupled with the battery monitor/charger 1778 to charge the battery 1776. In some examples, the power block 1780 may be replaced with a wireless power receiver to obtain the power wirelessly, for example, through a loop antenna in the edge computing node 1750. A wireless battery charging circuit, such as an LTC4020 chip from Linear Technologies of Milpitas, California, among others, may be included in the battery monitor/charger 1778. The specific charging circuits may be selected based on the size of the battery 1776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1758 may include instructions 1782 in the form of software, firmware, or hardware commands to implement the techniques described herein. Although such instructions 1782 are shown as code blocks included in the memory 1754 and the storage 1758, it may be understood that any of the code blocks may be replaced with hardwired circuits, for example, built into an application-specific integrated circuit (ASIC).

Also in a specific example, the instructions 1782 on the processor 1752 (separately, or in combination with the instructions 1782 of the machine readable medium 1760) may configure execution or operation of a trusted execution environment (TEE) 1790. In an example, the TEE 1790 operates as a protected area accessible to the processor 1752 for secure execution of instructions and secure access to data. Various implementations of the TEE 1790, and an accompanying secure area in the processor 1752 or the memory 1754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 1750 through the TEE 1790 and the processor 1752.

In an example, the instructions 1782 provided via the memory 1754, the storage 1758, or the processor 1752 may be embodied as a non-transitory, machine-readable medium 1760 including code to direct the processor 1752 to perform electronic operations in the edge computing node 1750. The processor 1752 may access the non-transitory, machine-readable medium 1760 over the interconnect 1756. For instance, the non-transitory, machine-readable medium 1760 may be embodied by devices described for the storage 1758 or may include specific storage units such as optical disks, flash drives, or any number of other hardware devices. The non-transitory, machine-readable medium 1760 may include instructions to direct the processor 1752 to perform a specific sequence or flow of actions, for example, as described with respect to the flowchart(s) and block diagram(s) of operations and functionality depicted above. As used herein, the terms “machine-readable medium” “machine-readable storage”, “computer-readable storage”, and “computer-readable medium” are interchangeable.

In an example embodiment, the edge computing node 1750 can be implemented using components/modules/blocks 1752-1786 which are configured as IP Blocks. Each IP Block may contain a hardware RoT (e.g., device identifier composition engine, or DICE), where a DICE key may be used to identify and attest the IP Block firmware to a peer IP Block or remotely to one or more of components/modules/blocks 1762-1780. Thus, it will be understood that the node 1750 itself may be implemented as a SoC or standalone hardware package.

In further examples, a machine-readable medium also includes any tangible medium that is capable of storing, encoding, or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 17A and 17B are intended to depict a high-level view of components of a device, subsystem, or arrangement of an edge computing node. However, it will be understood that some of the components shown may be omitted, additional components may be present, and a different arrangement of the components shown may occur in other implementations.

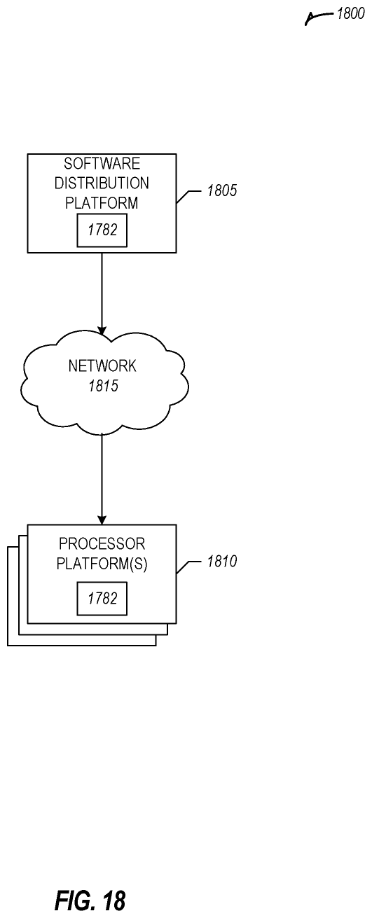

FIG. 18 illustrates an example software distribution platform 1805 to distribute software, such as the example computer-readable instructions 1782 of FIG. 17B, to one or more devices, such as processor platform(s) 1810 and/or other example connected edge devices or systems discussed herein. The example software distribution platform 1805 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1805). Example connected edge devices may operate in commercial and/or home automation environments. In some examples, a third party is a developer, a seller, and/or a licensor of software such as the example computer-readable instructions 1782 of FIG. 17B. The third parties may be consumers, users, retailers, OEMs, etc. that purchase and/or license the software for use and/or re-sale and/or sub-licensing. In some examples, distributed software causes the display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 18, the software distribution platform 1805 includes one or more servers and one or more storage devices that store the computer-readable instructions 1782. The one or more servers of the example software distribution platform 1805 are in communication with a network 1815, which may correspond to any one or more of the Internet and/or any of the example networks described above. In some examples, one or more servers are responsive to requests to transmit the software to a requesting party as part of a commercial transaction. Payment for the delivery, sale, and/or license of the software may be handled by one or more servers of the software distribution platform and/or via a third-party payment entity. The servers enable purchasers and/or licensors to download the computer-readable instructions 1782 from the software distribution platform 1805. For example, the software, which may correspond to example computer-readable instructions, may be downloaded to the example processor platform(s), which is/are to execute the computer-readable instructions 1782. In some examples, one or more servers of the software distribution platform 1805 are communicatively connected to one or more security domains and/or security devices through which requests and transmissions of the example computer-readable instructions 1782 must pass. In some examples, one or more servers of the software distribution platform 1805 periodically offer, transmit, and/or force updates to the software (e.g., the example computer-readable instructions 1782 of FIG. 17B) to ensure improvements, patches, updates, etc. are distributed and applied to the software at the end-user devices.

In the illustrated example of FIG. 18, the computer-readable instructions 1782 are stored on storage devices of the software distribution platform 1805 in a particular format. A format of computer-readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer-readable instructions 1782 stored in the software distribution platform 1805 are in a first format when transmitted to the example processor platform(s) 1810. In some examples, the first format is an executable binary in which particular types of the processor platform(s) 1810 can execute. However, in some examples, the first format is uncompiled code that requires one or more preparation tasks to transform the first format to a second format to enable execution on the example processor platform(s) 1810. For instance, the receiving processor platform(s) 1800 may need to compile the computer-readable instructions 1782 in the first format to generate executable code in a second format that is capable of being executed on the processor platform(s) 1810. In still other examples, the first format is interpreted code that, upon reaching the processor platform(s) 1810, is interpreted by an interpreter to facilitate the execution of instructions.

### ADDITIONAL EXAMPLES

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a first computing platform configured for dual application registration, the first computing platform comprising: communications circuitry to communicatively couple, via a network, the first computing platform with a second computing platform; and processing circuitry to: receive a dual application registration request from an application of the first computing platform; map a first application profile of the application at the first computing platform to a second application profile at the second computing platform; redirect the dual application registration request to the second computing platform, via the communications circuitry; receive an application registration acknowledgment, via the communications circuitry, in response to the redirect of the dual application registration request; and communicate the application registration acknowledgment to the application.

In Example 2, the subject matter of Example 1 optionally includes the processing circuitry further configured to: perform registration or an update of an existing registration of the application of the application at the first computing platform in response to the dual application registration request, the registration or the update of the existing registration occurring at the first computing platform before redirecting the dual application registration request.

In Example 3, the subject matter of any one or more of Examples 1-2 optionally include subject matter where the first computing platform is provided by a Multi-access Edge Computing (MEC) Platform, wherein the second computing platform is provided by an Edge Enabler Server (EES), and wherein the application is a MEC application instance operating in the MEC Platform.

In Example 4, the subject matter of Example 3 optionally includes subject matter where the dual application registration request is redirected to the second computing platform on behalf of the MEC application instance.

In Example 5, the subject matter of any one or more of Examples 3-4 optionally include subject matter where the redirect of the dual application registration request to the second computing platform is provided through a Core Network operating according to a 3GPP specification.

In Example 6, the subject matter of any one or more of Examples 3-5 optionally include subject matter where the MEC platform operates in a MEC system according to a European Telecommunications Standards Institute (ETSI) MEC specification.

In Example 7, the subject matter of any one or more of Examples 1-6 optionally include subject matter where the first computing platform is provided by an Edge Enabler Server (EES), wherein the second computing platform is provided by a Multi-access Edge Computing (MEC) Platform, wherein the application is an application instance operating an Edge Application Server (EAS), and wherein the dual application registration request includes data for the first application profile.

In Example 8, the subject matter of Example 7 optionally includes subject matter where the dual application registration request is redirected to the second computing platform on behalf of the EAS using a Mp1 reference point, and wherein the application registration acknowledgment is generated by the MEC Platform in response to registering the EAS at the MEC Platform.

In Example 9, the subject matter of any one or more of Examples 7-8 optionally include subject matter where the EES and the EAS operate according to a 3GPP EDGEAPP specification.

In Example 10, the subject matter of any one or more of Examples 1-9 optionally include subject matter where the dual application registration request received from the application includes the first application profile, and wherein the application registration acknowledgment identifies a communication endpoint of the second computing platform.

In Example 11, the subject matter of any one or more of Examples 1-10 optionally include subject matter where the application is accessible by a user equipment device on an edge of the network.

In Example 12, the subject matter of any one or more of Examples 1-11 optionally include subject matter where the processing circuitry is configured to: perform authentication of the application at the first computing platform, the authentication of the application occurring at the first computing platform before redirecting the dual application registration request; wherein, in response to the redirecting of the dual application registration request to the second computing platform, the second computing platform performs authentication of the application at the second computing platform.

Example 13 is a method performed at a computing device for dual application registration, for the computing device operating in a first computing platform of a network, the method comprising: receiving a dual application registration request from an application of the first computing platform; mapping a first application profile of the application at the first computing platform to a second application profile at a second computing platform; redirecting the dual application registration request to the second computing platform; receiving, in response to the redirect of the dual application registration request, an application registration acknowledgment; and communicating, to the application, the application registration acknowledgment.

In Example 14, the subject matter of Example 13 optionally includes performing registration of the application or an update of an existing registration of the application at the first computing platform in response to the dual application registration request, the registration or the update of the existing registration occurring at the first computing platform before redirecting the dual application registration request.

In Example 15, the subject matter of any one or more of Examples 13-14 optionally include subject matter where the first computing platform is provided by a Multi-access Edge Computing (MEC) Platform, wherein the second computing platform is provided by an Edge Enabler Server (EES), and wherein the application is a MEC application instance operating in the MEC Platform.

In Example 16, the subject matter of Example 15 optionally includes subject matter where the dual application registration request is redirected to the second computing platform on behalf of the MEC application instance.

In Example 17, the subject matter of any one or more of Examples 15-16 optionally include subject matter where the redirect of the dual application registration request to the second computing platform is provided through a Core Network operating according to a 3GPP specification.

In Example 18, the subject matter of any one or more of Examples 15-17 optionally include subject matter where the MEC platform operates in a MEC system according to a European Telecommunications Standards Institute (ETSI) MEC specification.

In Example 19, the subject matter of any one or more of Examples 13-18 optionally include subject matter where the first computing platform is provided by an Edge Enabler Server (EES), wherein the second computing platform is provided by a Multi-access Edge Computing (MEC) Platform, wherein the application is an application instance operating an Edge Application Server (EAS), and wherein the dual application registration request includes data for the first application profile.

In Example 20, the subject matter of Example 19 optionally includes subject matter where the dual application registration request is redirected to the second computing platform on behalf of the EAS using a Mp1 reference point, and wherein the application registration acknowledgment is generated by the MEC Platform in response to registering the EAS at the MEC Platform.

In Example 21, the subject matter of any one or more of Examples 19-20 optionally include subject matter where the EES and the EAS operate according to a 3GPP EDGEAPP specification.

In Example 22, the subject matter of any one or more of Examples 13-21 optionally include subject matter where the dual application registration request received from the application includes the first application profile, and wherein the application registration acknowledgment identifies a communication endpoint of the second computing platform.

In Example 23, the subject matter of any one or more of Examples 13-22 optionally include subject matter where the application is accessible by a user equipment device on an edge of the network.

In Example 24, the subject matter of any one or more of Examples 13-23 optionally include performing authentication of the application at the first computing platform, the authentication of the application occurring at the first computing platform before redirecting the dual application registration request; wherein, in response to the redirecting of the dual application registration request to the second computing platform, the second computing platform performs authentication of the application at the second computing platform.

Example 25 is at least one machine-readable storage medium comprising instructions stored thereupon, which when executed by processing circuitry of a computing machine, cause the processing circuitry to perform the operations of any one or more of Examples 13 to 24.

Example 26 is a system, comprising: a first computing platform; and a second computing platform; the first and second computing platform communicatively coupled on a network; wherein the first computing platform comprises: at least one memory including instructions; and processing circuitry that, when in operation, is configured by the instructions to: receive a dual application registration request from an application of the first computing platform; map a first application profile of the application at the first computing platform to a second application profile at the second computing platform; redirect the dual application registration request to the second computing platform; receive, in response to the redirect of the dual application registration request, an application registration acknowledgment; and communicate, to the application, the application registration acknowledgment; wherein the second computing platform comprises: at least one memory including instructions; and processing circuitry that, when in operation, is configured by the instructions to: receive the dual application registration request from the first computing platform; and transmit the application registration acknowledgment to the first computing platform, in response to the dual application registration request.

In Example 27, the subject matter of Example 26 optionally includes subject matter where the first computing platform operates in a Multi-access Edge Computing (MEC) system according to a European Telecommunications Standards Institute (ETSI) MEC specification.

In Example 28, the subject matter of Example 27 optionally includes subject matter where the first computing platform is provided by a MEC Platform, wherein the second computing platform is provided by an Edge Enabler Server (EES), wherein the application is a MEC application instance operating in the MEC Platform, and wherein the dual application registration request is redirected to the second computing platform on behalf of the MEC application instance.

In Example 29, the subject matter of any one or more of Examples 26-28 optionally include subject matter where the first computing platform is provided by an Edge Enabler Server (EES), wherein the second computing platform is provided by a Multi-access Edge Computing (MEC) Platform, wherein the application is an application instance operating an Edge Application Server (EAS), and wherein the EES and the EAS operate according to a 3GPP EDGEAPP specification.

In Example 30, the subject matter of Example 29 optionally includes subject matter where the dual application registration request includes data for the first application profile, wherein the application registration acknowledgment is generated by the MEC Platform in response to registering the EAS at the MEC Platform, and wherein the dual application registration request is redirected to the second computing platform on behalf of the EAS using a Mp1 reference point.

Example 31 is an apparatus, comprising: means for receiving a dual application registration request from an application of a first computing platform; means for mapping a first application profile of the application at the first computing platform to a second application profile at a second computing platform; means for redirecting the dual application registration request to the second computing platform; means for receiving, in response to the redirect of the dual application registration request, an application registration acknowledgment; and means for communicating, to the application, the application registration acknowledgment.

In Example 32, the subject matter of Example 31 optionally includes means for performing registration of the application or an update of an existing registration of the application at the first computing platform in response to the dual application registration request, the registration or the update of the existing registration occurring at the first computing platform before redirecting the dual application registration request.

In Example 33, the subject matter of any one or more of Examples 31-32 optionally include subject matter where the first computing platform is provided by a Multi-access Edge Computing (MEC) Platform, wherein the second computing platform is provided by an Edge Enabler Server (EES), and wherein the application is a MEC application instance operating in the MEC Platform.

In Example 34, the subject matter of Example 33 optionally includes subject matter where the dual application registration request is redirected to the second computing platform on behalf of the MEC application instance.

In Example 35, the subject matter of any one or more of Examples 33-34 optionally subject matter where the redirect of the dual application registration request to the second computing platform is provided through a Core Network operating according to a 3GPP specification.

In Example 36, the subject matter of any one or more of Examples 33-35 optionally include means for operating the MEC platform in a MEC system according to a European Telecommunications Standards Institute (ETSI) MEC specification.

In Example 37, the subject matter of any one or more of Examples 31-36 optionally include subject matter where the first computing platform is provided by an Edge Enabler Server (EES), wherein the second computing platform is provided by a Multi-access Edge Computing (MEC) Platform, wherein the application is an application instance operating an Edge Application Server (EAS), and wherein the dual application registration request includes data for the first application profile.

In Example 38, the subject matter of Example 37 optionally includes subject matter where the dual application registration request is redirected to the second computing platform on behalf of the EAS using a Mp1 reference point, and wherein the application registration acknowledgment is generated by the MEC Platform in response to registering the EAS at the MEC Platform.

In Example 39, the subject matter of any one or more of Examples 37-38 optionally include means for operating the EES and the EAS according to a 3GPP EDGEAPP specification.

In Example 40, the subject matter of any one or more of Examples 31-39 optionally include subject matter where the dual application registration request received from the application includes the first application profile, and wherein the application registration acknowledgment identifies a communication endpoint of the second computing platform.

In Example 41, the subject matter of any one or more of Examples 31-40 optionally include means for making the application accessible to a user equipment device on an edge of a network.

In Example 42, the subject matter of any one or more of Examples 31-41 optionally include means for performing authentication of the application at the first computing platform, the authentication of the application occurring at the first computing platform before redirecting the dual application registration request; wherein, in response to the redirecting of the dual application registration request to the second computing platform, the second computing platform performs authentication of the application at the second computing platform.

Example 43 is an apparatus comprising means to implement any of Examples 1-42.

Example 44 is a system to implement any of Examples 1-42.

Example 45 is a method to implement any of Examples 1-42.

Example 46 is an edge computing system, comprising networking and processing components to communicate with a user equipment device, client computing device, provisioning device, or management device to implement any of Examples 1-42.

Example 47 is networking hardware with network functions implemented thereupon, operable within an edge computing system, the network functions configured to implement any of Examples 1-42.

Example 48 is storage hardware with storage capabilities implemented thereupon, operable in an edge computing system, the storage hardware configured to implement any of Examples 1-42.

Example 49 is computation hardware with compute capabilities implemented thereupon, operable in an edge computing system, the computation hardware configured to implement any of Examples 1-42.

Example 50 is a computer program used in an edge computing system, the computer program comprising instructions, wherein execution of the program by a processing element in the edge computing system is to cause the processing element to implement any of Examples 1-42.

Example 51 is an edge computing appliance device operating as a self-contained processing system, comprising a housing, case, or shell, network communication circuitry, storage memory circuitry, and processor circuitry adapted to implement any of Examples 1-42.

Example 52 is an apparatus of an edge computing system comprising means to implement any of Examples 1-42.

Example 53 is an apparatus of an edge computing system comprising logic, modules, or circuitry to implement any of Examples 1-42.

Example 54 is an edge computing system, including respective edge processing devices and nodes to invoke or perform any of the operations of Examples 1-42, or other subject matter described herein.

Example 55 is an edge computing system including aspects of network functions, acceleration functions, acceleration hardware, storage hardware, or computation hardware resources, operable to invoke or perform the use cases discussed herein, with use of any Examples 1-42, or other subject matter described herein.

Although these implementations have been described concerning specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is disclosed. Thus, although specific aspects have been illustrated and described herein, it should be appreciated that any arrangement calculated to achieve the same purpose may be substituted for the specific aspects shown. This disclosure is intended to cover any adaptations or variations of various aspects. Combinations of the above aspects and other aspects not specifically described herein will be apparent to those of skill in the art upon reviewing the above description.

What is claimed is:

1. A first computing platform configured for dual application registration, the first computing platform comprising:
communications circuitry to communicatively couple, via a network, the first computing platform with a second computing platform; and
processing circuitry to:
receive a dual application registration request from an application of the first computing platform;
map a first application profile of the application at the first computing platform to a second application profile at the second computing platform;
redirect the dual application registration request to the second computing platform, via the communications circuitry;
receive an application registration acknowledgment, via the communications circuitry, in response to the redirect of the dual application registration request; and
provide the application registration acknowledgment to the application.

2. The first computing platform of claim 1, the processing circuitry further configured to:
perform registration of the application or an update of an existing registration of the application at the first computing platform in response to the dual application registration request, the registration or the update of the existing registration occurring at the first computing platform before redirecting the dual application registration request.

3. The first computing platform of claim 1, wherein the first computing platform is provided by a Multi-access Edge Computing (MEC) Platform, wherein the second computing platform is provided by an Edge Enabler Server (EES), and wherein the application is a MEC application instance operating in the MEC Platform.

4. The first computing platform of claim 3, wherein the dual application registration request is redirected to the second computing platform on behalf of the MEC application instance.

5. The first computing platform of claim 3, wherein the redirect of the dual application registration request to the second computing platform is provided through a Core Network operating according to a 3GPP specification.

6. The first computing platform of claim 3, wherein the MEC platform operates in a MEC system according to a European Telecommunications Standards Institute (ETSI) MEC specification.

7. The first computing platform of claim 1, wherein the first computing platform is provided by an Edge Enabler Server (EES), wherein the second computing platform is provided by a Multi-access Edge Computing (MEC) Platform, wherein the application is an application instance operating an Edge Application Server (EAS), and wherein the dual application registration request includes data for the first application profile.

8. The first computing platform of claim 7, wherein the dual application registration request is redirected to the second computing platform on behalf of the EAS using a Mp1 reference point, and wherein the application registration acknowledgment is generated by the MEC Platform in response to registering the EAS at the MEC Platform.

9. The first computing platform of claim 7, wherein the EES and the EAS operate according to a 3GPP EDGEAPP specification.

10. The first computing platform of claim 1, wherein the dual application registration request received from the application includes the first application profile, and wherein the application registration acknowledgment identifies a communication endpoint of the second computing platform.

11. The first computing platform of claim 1, wherein the application is accessible by a user equipment device on an edge of the network.

12. The first computing platform of claim 1, wherein the processing circuitry is configured to:
perform authentication of the application at the first computing platform, the authentication of the application occurring at the first computing platform before redirecting the dual application registration request;
wherein, in response to the redirecting of the dual application registration request to the second computing platform, the second computing platform performs authentication of the application at the second computing platform.

13. A method performed at a computing device for dual application registration, for the computing device operating in a first computing platform of a network, the method comprising:
receiving a dual application registration request from an application of the first computing platform;
mapping a first application profile of the application at the first computing platform to a second application profile at a second computing platform;
redirecting the dual application registration request to the second computing platform;
receiving, in response to the redirect of the dual application registration request, an application registration acknowledgment; and
communicating, to the application, the application registration acknowledgment.

14. The method of claim 13, further comprising:
performing registration of the application or an update of an existing registration at the first computing platform in response to the dual application registration request, the registration or the update of the existing registration occurring at the first computing platform before redirecting the dual application registration request.

15. The method of claim 13, wherein the first computing platform is provided by a Multi-access Edge Computing (MEC) Platform, wherein the second computing platform is provided by an Edge Enabler Server (EES), and wherein the application is a MEC application instance operating in the MEC Platform.

16. The method of claim 15, wherein the dual application registration request is redirected to the second computing platform on behalf of the MEC application instance.

17. The method of claim 15, wherein the redirect of the dual application registration request to the second computing platform is provided through a Core Network operating according to a 3GPP specification.

18. The method of claim 15, wherein the MEC platform operates in a MEC system according to a European Telecommunications Standards Institute (ETSI) MEC specification.

19. The method of claim 13, wherein the first computing platform is provided by an Edge Enabler Server (EES), wherein the second computing platform is provided by a Multi-access Edge Computing (MEC) Platform, wherein the application is an application instance operating an Edge Application Server (EAS), and wherein the dual application registration request includes data for the first application profile.

20. The method of claim 19, wherein the dual application registration request is redirected to the second computing platform on behalf of the EAS using a Mp1 reference point, and wherein the application registration acknowledgment is generated by the MEC Platform in response to registering the EAS at the MEC Platform.

21. The method of claim 19, wherein the EES and the EAS operate according to a 3GPP EDGEAPP specification.

22. The method of claim 13, wherein the dual application registration request received from the application includes the first application profile, and wherein the application registration acknowledgment identifies a communication endpoint of the second computing platform.

23. The method of claim 13, wherein the application is accessible by a user equipment device on an edge of the network.

24. The method of claim 13, further comprising:
performing authentication of the application at the first computing platform, the authentication of the application occurring at the first computing platform before redirecting the dual application registration request;
wherein, in response to the redirecting of the dual application registration request to the second computing platform, the second computing platform performs authentication of the application at the second computing platform.

25. At least one machine-readable storage medium comprising instructions stored thereupon, which when executed by processing circuitry of a computing machine, cause the processing circuitry to perform the operations of any one or more of claims 13 to 24.

26. A system, comprising:
a first computing platform; and
a second computing platform;
the first and second computing platform communicatively coupled on a network;
wherein the first computing platform comprises:
at least one memory including instructions; and
processing circuitry that, when in operation, is configured by the instructions to:
receive a dual application registration request from an application of the first computing platform;
map a first application profile of the application at the first computing platform to a second application profile at the second computing platform;
redirect the dual application registration request to the second computing platform;
receive, in response to the redirect of the dual application registration request, an application registration acknowledgment; and provide, to the application, the application registration acknowledgment;
wherein the second computing platform comprises:
at least one memory including instructions; and
processing circuitry that, when in operation, is configured by the instructions to:
receive the dual application registration request from the first computing platform; and
transmit the application registration acknowledgment to the first computing platform, in response to the dual application registration request.

27. The system of claim 26,
wherein the first computing platform operates in a Multi-access Edge Computing (MEC) system according to a European Telecommunications Standards Institute (ETSI) MEC specification.

28. The system of claim 27,
wherein the first computing platform is provided by a MEC Platform, wherein the second computing platform is provided by an Edge Enabler Server (EES),
wherein the application is a MEC application instance operating in the MEC Platform, and
wherein the dual application registration request is redirected to the second computing platform on behalf of the MEC application instance.

29. The system of claim 26,
wherein the first computing platform is provided by an Edge Enabler Server (EES),
wherein the second computing platform is provided by a Multi-access Edge Computing (MEC) Platform,
wherein the application is an application instance operating an Edge Application Server (EAS), and
wherein the EES and the EAS operate according to a 3GPP EDGEAPP specification.

30. The system of claim 29,
wherein the dual application registration request includes data for the first application profile,
wherein the application registration acknowledgment is generated by the MEC Platform in response to registering the EAS at the MEC Platform, and
wherein the dual application registration request is redirected to the second computing platform on behalf of the EAS using a Mp1 reference point.
